(19) United States
(12) Patent Application Publication
(10) Pub. No.: US 2009/0021671 A1
(43) Pub. Date: Jan. 22, 2009

(54) Cellulose Acylate Film, Method for Producing Cellulose Acylate Film, Polarizing Plate and Liquid Crystal Display Device

(75) Inventors: Nobutaka Fukagawa, Kanagawa (JP); Tadashi Omatsu, Kanagawa (JP); Yutaka Nozoe, Kanagawa (JP); Takuya Inoue, Kanagawa (JP); Naoki Hayashi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/815,986

(22) PCT Filed: Feb. 24, 2006
(86) PCT No.: PCT/JP2006/304025

§ 371 Date: Aug. 10, 2007

(30) Foreign Application Priority Data
Mar. 3, 2005 (JP) 2005-058957

(51) Int. Cl. G02F 1/1335; C08J 5/18; C08J 5/20; C08L 1/10; G02B 5/30

(52) U.S. Cl. 349/96; 264/342 R; 428/532; 428/1.1; 359/485

(57) ABSTRACT

A method for producing a cellulose acylate film containing an additive comprising an aliphatic compound, the method contains a process of thermal shrinkage treatment at an atmospheric temperature higher than the glass transition temperature (Tg) in the state where at least one of the transverse direction and the machine direction of the film is free, and a cellulose acylate film obtained by the above method.

### TECHNICAL FIELD

The present invention relates to a cellulose acylate film, a producing method of a cellulose acylate film, a polarizing plate, and a liquid crystal display device.

### BACKGROUND ART

Liquid crystal display devices are widening the usage year by year as image display devices requiring low consumption of electric power and a small space. Having large viewing angle dependency of images is a big defect of liquid crystal display devices, however, liquid crystal modes such as VA mode and IPS mode having high angle of visibility have been put to practical use in recent years. As a result, the demand for liquid crystal displays is rapidly spreading also on the market requiring high angle of visibility such as televisions.

With such a tendency, polarizing plates for use in liquid crystal displays are required to have further higher performances, and polarizing plates provided with a certain kind of optical compensation performance have been widely used.

As the polarizing plate for a liquid crystal display, a polarizing plate comprising a polarizer formed by stretching a polyvinyl alcohol film dyed with an iodine and sticking protective films on both sides thereof is generally used. Optical compensation performances are generally provided to the polarizing plate by coating an optically anisotropic layer or sticking a retardation film, such as a stretched polymer film, on the protective film of the polarizing plate.

Cellulose acylate films conventionally used as the protective films of polarizing plates are characterized in that they are small in retardation as compared with other polymer films, e.g., polycarbonate and polyethylene phthalate, but a protective film of a polarizing plate having further higher optical isotropy has been required, since even the retardation of cellulose acylate is a hindrance to compensation when more precise optical compensation is aimed.

Concerning this problem, methods for further reducing the retardation of cellulose acylate are discussed. As one such an example, a method of adding a compound having high affinity with cellulose acylate to a cellulose acylate film is proposed. For example, a cellulose acylate film containing an additive having an octanol/water distribution coefficient (logP) of from 1 to 10 is disclosed in JP-A-2004-315613 (the term “JP-A” as used herein refers to an “unexamined published Japanese patent application”).

However, these methods are accompanied by various drawbacks, such that (1) the fluctuations of retardation and dimension of films are great due to temperature and humidity, (2) the additives contained in films evaporate in high temperature drying in a film-forming process and a polarizing plate-forming process, which are again stuck to the films to thereby cause facial defects, (3) additives eluted into a saponification solution during saponification treatment, which is performed for the security of adhesion of a protective film with PVA of a polarizer, are decomposed and precipitated, which cause the reduction of saponification property of the saponification solution and facial defects, and (4) the fluctuation of retardation of films by saponification treatment is great, and so the improvements of these problems are strongly desired.

### DISCLOSURE OF THE INVENTION

An object of the invention is to provide a protective film of a polarizing plate stable in retardation and dimensional stability in various use environments. Another object of the invention is to provide a polarizing plate free from facial defects and excellent in optical compensation performances.

A further object of the invention is to provide a high grade liquid crystal display device by using a polarizing plate having stable optical compensation performances in various use environments in the liquid crystal display device.

As a result of eager investigation, the present inventors have found that the free volumes among cellulose acylate molecular chains are reduced by subjecting a cellulose acylate film containing an additive having high affinity with cellulose acylate to thermal shrinkage treatment at an atmospheric temperature higher than the glass transition temperature (Tg), whereby the interaction between the additive and the cellulose acylate film is increased, as a result, the retention of the additive is conspicuously improved. It was also found that this effect is especially remarkable in aliphatic compounds not having a stiff structure such as an aromatic ring. Since the retention of additives can be improved, the eluting amount of additives from films during saponification treatment and under high temperature environments can be reduced.

It has been also found that the fluctuations due to use environments of retardations and dimensions of cellulose acylate films subjected to the above thermal shrinkage treatment can be sharply reduced, thus the present invention has been accomplished.

(1) A cellulose acylate film, which has an in-plane retardation Re and a retardation in a thickness direction Rth at 25° C., 60% RH satisfying relationships of equations (A) and (B),

wherein an amount of an elution of an additive per 100 g of the cellulose acylate film is 100 mg or less when the cellulose acylate film is immersed in 1 liter of 1.5 mmol/liter of sodium hydroxide solution at 55° C. for 10 minutes:

0 nm≦Re(λ)≦10 nm (A)

−25 nm≦Rth(λ)≦25 μm (B)

wherein Re (λ) and Rth (λ) represent Re and Rth measured at a wavelength of λ nm respectively; and

λ is from 400 to 700 nm.

(2) A cellulose acylate film, which has an in-plane retardation Re and a retardation in a thickness direction Rth at 25° C., 60% RH satisfying relationships of equations (A) and (B),

wherein variations in the retardations Re and Rth at 25° C., 60% RH before and after immersion of the cellulose acylate film in 1.5 mol/liter of sodium hydroxide solution at 55° C. for 10 minutes satisfy relationships of equations (C) and (D):

0 nm≦Re(590)≦10 nm (A)

−25 nm≦Rth(590)≦25 nm (B)

−2 nm≦[(Re before immersion treatment)−(Re after immersion treatment)]≦2 nm (C)

−3 nm≦[(Rth before immersion treatment)−(Rth after immersion treatment)]≦3 nm (D)

wherein in the equations (A) and (B), Re (590) and Rth (590) represent Re and Rth measured at a wavelength of 590 nm, respectively; and

in equations (C) and (D), Re and Rth are values at a wavelength of 590 nm.

(3) A cellulose acylate film, which has an in-plane retardation Re and a retardation in a thickness direction Rth at 25° C., 60% RH satisfying relationships of equations (A) and (B),

wherein a residual rate of an additive in the cellulose acylate film after aging at 140° C. for 10 hours is 98% or more:

0 nm≦Re(λ)≦10 nm (A)

−25 nm≦Rth(λ)≦25 nm (B)

wherein Re (λ) and Rth (λ) represent Re and Rth measured at a wavelength of λnm, respectively; and

λ is from 400 to 700 nm.

(4) A cellulose acylate film, which has an in-plane retardation Re and a retardation in a thickness direction Rth at 25° C., 60% RH satisfying relationships of equations (A) and (B),

wherein orientation coefficients of a main chain and a carbonyl group in the cellulose acylate film satisfy relationships of equations (E) to (H):

0 nm≦Re(λ)≦10 nm (A)

−25 nm≦Rth(λ)≦25 nm (B)

0.02≦an orientation coefficient of a main chain in a thickness direction≦0.20 (E)

−0.04≦an orientation coefficient of a main chain in an in-plane direction≦0.10 (F)

−0.10≦an orientation coefficient of a carbonyl group in a thickness direction≦−0.02 (G)

−0.10≦an orientation coefficient of a carbonyl group in an in-plane direction≦0.02 (H)

wherein in equations (A) and (B), Re (λ) and Rth (λ) represent Re and Rth measured at a wavelength of λ nm, respectively; and

λ is from 400 to 700 nm,

(5) A method for producing a cellulose acylate film comprising:

a process of subjecting a cellulose acylate film that comprises an additive comprising an aliphatic compound to thermal shrinkage treatment at an atmospheric temperature higher than a glass transition temperature Tg in a state where at least one of a transverse direction and a machine direction of the cellulose acylate film is free.

(6) The cellulose acylate film as described in any of (1) to (4) above, which is produced by a method as described in (5) above.

(7) The cellulose acylate film as described in (6) above,

wherein the aliphatic compound has at least one non-dissociable polar group and an octanol/water distribution coefficient (logP) of from 1 to 10.

(8) The cellulose acylate film as described in (6) or (7) above,

wherein the aliphatic compound is a compound represented by formula (1):

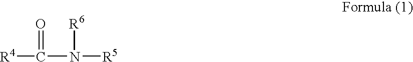

wherein R⁴, R⁵ and R⁶ each independently represents an alkyl group, which may have a substituent.

(9) The cellulose acylate film as described in any of (1) to (4) and (6) to (8) above,

wherein a ratio of a sonic speed in a machine direction MD and a sonic speed in a transverse direction TD satisfies equation (I):

1.0<(sonic speed in MD)/(sonic speed in TD)<1.1 (I)

(10) The cellulose acylate film as described in any of (1) to (4) and (6) to (9) above,

wherein a difference between Re (590) at 25° C. 80% RH and Re (590) at 25° C. 10% RH is from −10 to 10 nm.

(11) The cellulose acylate film as described in any of (1) to (4) and (6) to (10) above,

wherein a difference between Rth (590) at 25° C. 80% RH and Rth (590) at 25° C. 10% RH is from −30 to 30 nm.

(12) The cellulose acylate film as described in any of (1) to (4) and (6) to (11) above,

wherein each of a dimensional variation in a machine direction MD and a dimensional variation in a transverse direction TD before and after aging at 100° C. for 250 hours is from −0.15 to 0.15%.

(13) A polarizing plate comprising:

a polarizer, and

at least two protective films stuck on both sides of the polarizer,

wherein at least one of the at least two protective films is a cellulose acylate film as described in any of (1) to (4) and (6) to (12) above.

(14) The polarizing plate as described in (13) above, which has an optical compensation performance.

(15) A liquid crystal display device comprising:

a liquid crystal cell; and

at least two polarizing plates arranged on both sides of the liquid crystal cell,

wherein at least one of the at least two polarizing plates is a polarizing plate as described in (13) or (14) above.

### BRIEF DESCRIPTION OF THE DRAWING

FIG. 1 is a view showing four fundamental optical arrangements in the measurement by a polarization ATR method;

FIG. 2 is an example of a construction of composite comprising the polarizing plate of the invention and a functional optical film; and

FIG. 3 is an example of a liquid crystal display device in which the polarizing plate of the invention is used,

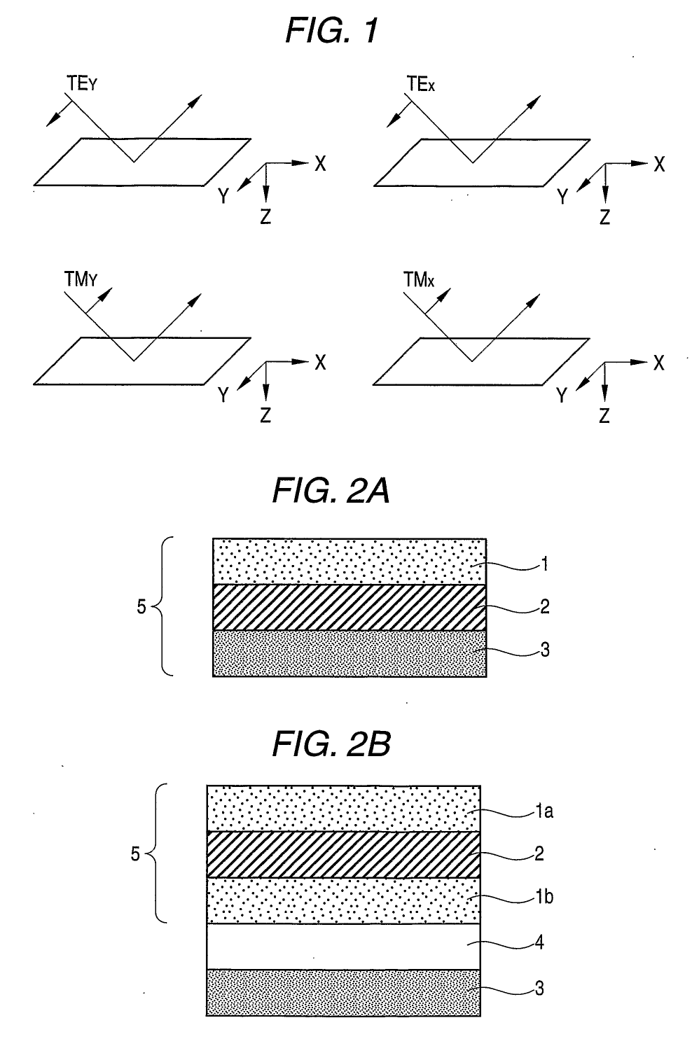

Wherein 1, 1a, 1b denote Protective films; 2 denotes Polarizer; 3 denotes Functional optical film; 4 denotes Adhesive layer, 5 denotes Polarizing plate; 6 denotes Upper polarizing plate; 7 denotes Upper polarizing plate absorption axis; 8 denotes Upper optically anisotropic layer; 9 denotes Orientation controlling direction of upper optically anisotropic layer; 10 denotes Electrode substrate on liquid crystal cell; 11 denotes Orientation controlling direction of upper substrate; 12 denotes Liquid crystal molecule; 13 denotes Electrode substrate under liquid crystal cell; 14 denotes Orientation controlling direction of lower substrate; 15 denotes Lower optically anisotropic layer; 16 denotes Orientation controlling direction of lower optically anisotropic layer; 17 denotes Lower polarizing plate; and 18 denotes Lower polarizing plate absorption axis.

### BEST MODE FOR CARRYING OUT THE INVENTION

The cellulose acylate film in the invention is produced by subjecting a film containing an additive comprising a compound having high affinity with cellulose acylate, not having an aromatic ring, and having an effect of capable of lowering retardation (hereinafter referred to as a retardation decreasing agent) to thermal shrinkage treatment at an atmospheric temperature higher than Tg in the state where at least one of the transverse direction and the machine direction of the film is free.

Cellulose acylates, retardation decreasing agents, the producing methods of cellulose acylate films, the characteristics of cellulose acylate films, polarizing plates and the producing methods thereof, and liquid crystal display devices are explained below in the order.

### [Cellulose Acylate Film]

The cellulose acylate film in the invention is described in the first place.

The degree of substitution of cellulose acylate means the ratio of acylation of three hydroxyl groups present in the constitutional unit of cellulose (β1→4 glycoside bound glucose). The degree of substitution can be calculated by measuring the amount of bound fatty acid per the constitutional unit weight of cellulose. The measuring method is according to ASTM-D8179-91.

The following two types of cellulose acylates are preferably used in the invention.

The first type is cellulose acetate having an acetylation degree of from 2.7 to 3.0, more preferably from 2.85 to 2.98, and most preferably from 2.90 to 2.97.

The second type is cellulose acylates having two or more acyl groups having from 2 to 6 carbon atoms. The degree of acylation is preferably from 2.6 to 2.98, and more preferably from 2.7 to 2.95. As the acyl groups, an acetyl group, a propionyl group and a butyryl group are preferably used. When the cellulose acylate film in the invention has an acetyl group and other acyl group, the substitution degree of the acetyl group is preferably less than 2.5, and more preferably less than 2.0.

The cellulose acylate in the invention preferably has a weight average molecular weight of from 350 to 800, and more preferably from 370 to 600. The cellulose acylate in the invention preferably has a number average molecular weight of from 70,000 to 230,000, more preferably from 75,000 to 230,000, and most preferably from 78,000 to 120,000.

The cellulose acylate of the invention can be synthesized by using an acid anhydride or an acid chloride as an acylating agent. When the acylating agent is an acid anhydride, an organic acid (for example, acetic acid) or methylene chloride is used as a reaction solvent. A protonic catalyst such as sulfuric acid is used as a catalyst. When the acylating agent is an acid chloride, a basic compound is used as a catalyst. In the most general synthesis method from the industrial standpoint, a cellulose is esterified with a mixed organic acid component containing an organic acid corresponding to the acetyl group and other acyl group (for example, acetic acid, propionic acid, and butyric acid) or an acid anhydride thereof (for example, acetic anhydride, propionic anhydride, and butyric anhydride), thereby synthesizing a cellulose acylate. In this method, in many cases, a cellulose such as cotton linter and wood pulp is activated with an organic acid such as acetic acid and then esterified using a mixed liquid of the foregoing organic acid component in the presence of a sulfuric acid catalyst. The organic acid anhydride component is in general used in an excessive amount against the amount of the hydroxyl groups present in the cellulose. In this esterification treatment, a hydrolysis reaction (depolymerization reaction) of the cellulose principal chain (β1→4 glycoside bond) proceeds in addition to the esterification reaction. When the hydrolysis reaction of the principal chain proceeds, the degree of polymerization of the cellulose ester is lowered, whereby physical properties of the cellulose ester as produced is lowered. For that reason, it is preferable that the reaction condition such as reaction temperature is determined while taking into consideration the degree of polymerization and molecular weight of the cellulose acylate to be obtained.

In order to obtain a cellulose acylate having a high degree of polymerization (high molecular weight), it is important to regulate the maximum temperature in the esterification reaction step at not higher than 50° C. The maximum temperature is regulated preferably at from 35 to 50° C., and more preferably at from 37 to 47° C. When the reaction temperature is lower than 35° C., the esterification reaction may possibly not proceed smoothly. When the reaction temperature exceeds 50° C., the degree of polymerization of the cellulose acylate is liable to be lowered. After the esterification reaction, by stopping the reaction while suppressing the temperature rise, a lowering of the degree of polymerization can be further suppressed, and a cellulose acylate having a high degree of polymerization can be synthesized. That is, when a reaction stopping agent (for example, water and acetic acid) is added after completion of the reaction, the excessive acid anhydride which has not contributed to the esterification reaction is hydrolyzed to form a corresponding organic acid as a by-product. This hydrolysis reaction is accompanied with vigorous heat generation so that the temperature within a reaction device increases. When the rate of addition of the reaction stopping agent is high, a cooling capacity of the reaction device is exceeded so that the heat generation abruptly occurs. For that reason, the hydrolysis reaction of the cellulose principal chain markedly proceeds, whereby the degree of polymerization of the resulting cellulose acylate is lowered. Furthermore, a part of the catalyst is coupled with the cellulose during the esterification reaction, and the major part thereof is dissociated from the cellulose during the addition of the reaction stopping agent. However, when the rate of addition of the reaction stopping agent is high, the reaction time for dissociating the catalyst is not sufficient so that a part of the catalyst remains in the coupled state with the cellulose. A cellulose acylate in which a strong acid catalyst is partially coupled is very poor in stability so that it is readily decomposed by heat at the time of drying of a product or the like, leading to a lowering of the degree of polymerization. For these reasons, it is desired that after the esterification reaction, the reaction stopping agent is added preferably for 4 minutes or more, and more preferably for from 4 to 30 minutes, thereby stopping the reaction. Incidentally, when the time of addition of the reaction stopping agent exceeds 30 minutes, the industrial productivity is lowered. In general, water or an alcohol capable of decomposing the acid anhydride is used as the reaction stopping agent. However, in the invention, in order to avoid the deposition of a triester having low solubility in various organic solvents, a mixture of water and an organic acid is preferably used as the reaction stopping agent. When the esterification reaction is carried out under the foregoing condition, a cellulose acylate with high molecular weight having a weight average polymerization degree of 500 or more can be easily synthesized.

The additives contained in the cellulose acylate in the invention are explained.

As the additives contained in the cellulose acylate film in the invention, in addition to a retardation decreasing agent, a deterioration (degradation)-preventing agent, a UV absorber and a plasticizer are exemplified.

### (Retardation Decreasing Agent)

As the retardation decreasing agent, an aliphatic compound having high affinity with the cellulose acylate film is contained in the cellulose acylate film in the invention. The aliphatic compound is a compound not having an aromatic ring structure in the molecule.

Of the aliphatic compounds, compounds having an octanol/water distribution coefficient (logP) of from 1 to 10 are preferred, and those having logP of from 2 to 9 are more preferred. When logP is too low, a retardation decreasing agent is liable to be eluted into a saponification solution in saponification treatment, and so not preferred. While when logP is too high, the affinity of the compound with the cellulose acylate is low, so that the retardation decreasing effect is insufficient.

An octanol/water distribution coefficient (logP) can be measured with n-octanol and water, but in the invention, the predictive value of the distribution coefficient can be found with a logP value prediction program (CLOGP Program built in PC models of Daylight Chemical Information Systems).

It is preferred that the aliphatic compound has at least one non-dissociable polar group. Here, “inon-dissociable” means not to be substantially dissociable in a high alkali aqueous solution having pH of 13 or more.

As the non-dissociable polar groups, a carbonamido group, an amino group, a hydroxyl group, a phosphate group, and a phosphinate group are preferred. By having a non-dissociable polar group, the retention of a retardation decreasing agent in a film at the time of saponification can be reconciled with the affinity of a retardation decreasing agent with the cellulose acylate film.

The molecular weight of the retardation decreasing agent of the invention is preferably from 300 to 1,000, and more preferably from 350 to 750. When the molecular weight is too small, the evaporation of the retardation decreasing agent in a process subjected to a high temperature, such as a drying process, causes a problem. When the molecular weight is too great, the affinity with cellulose acylate becomes insufficient.

As preferred aliphatic compounds in the invention, the following compounds are exemplified. The numerals in parentheses represent logP values.

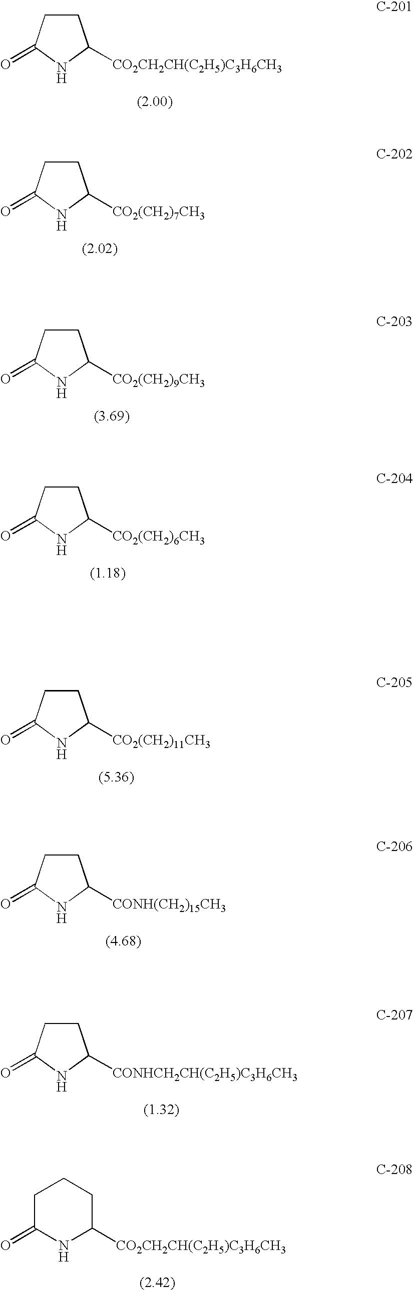

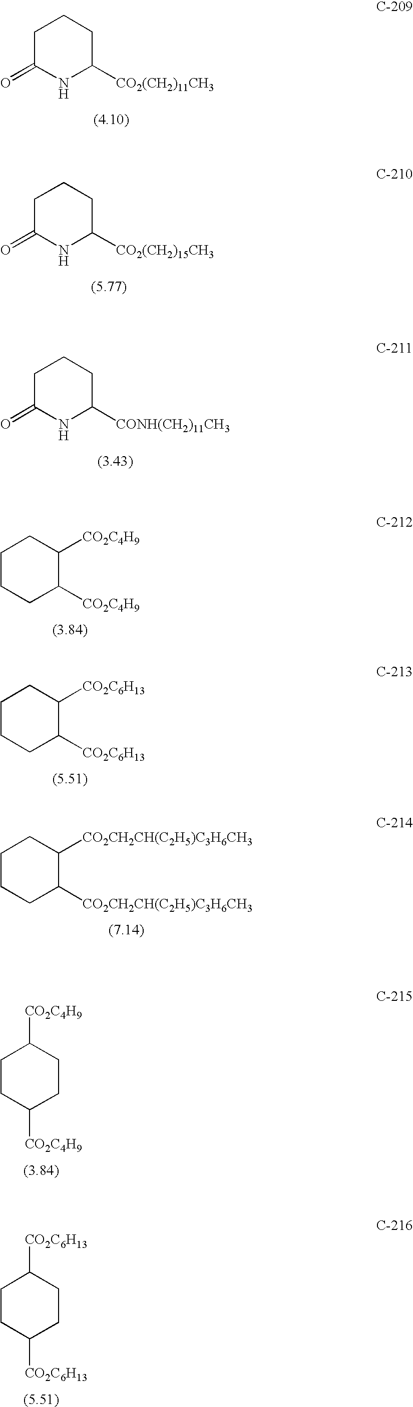

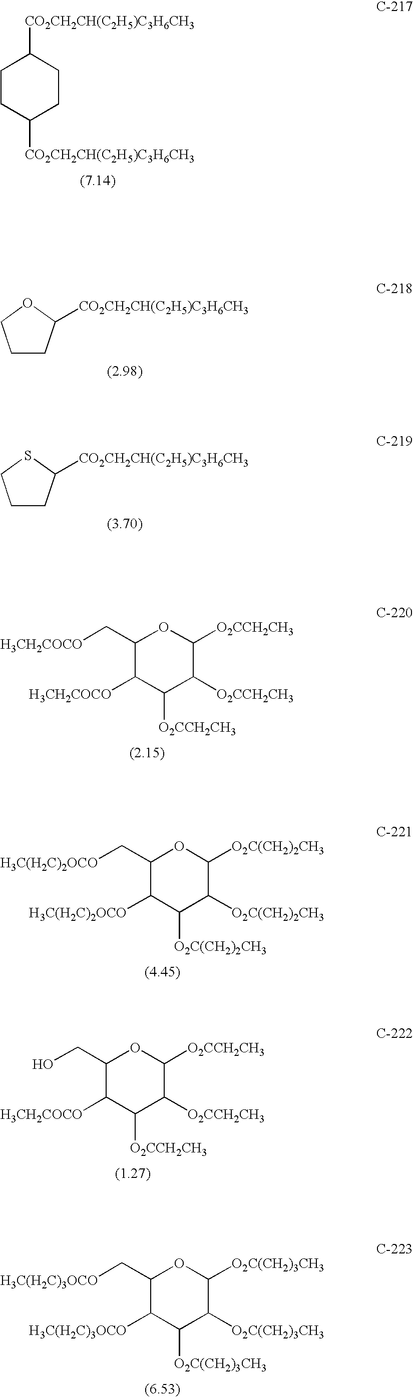

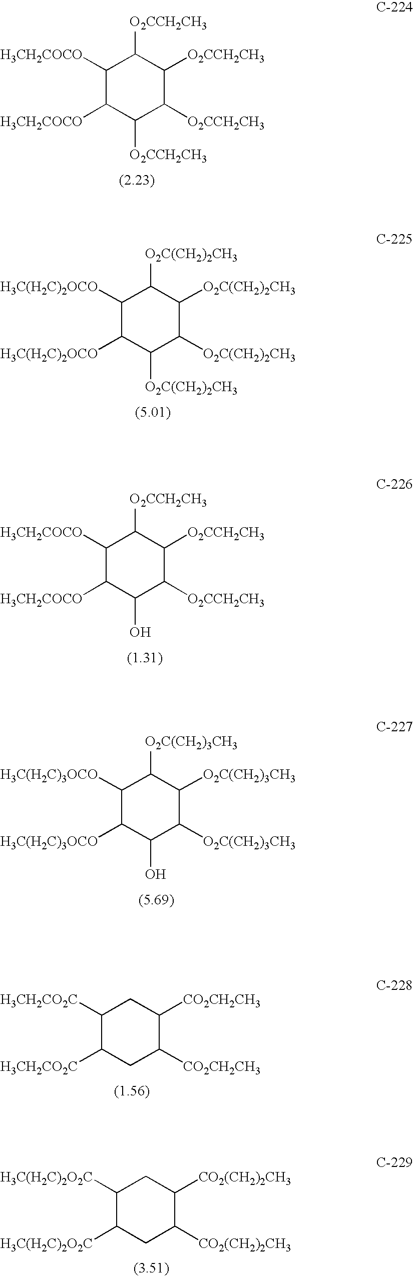

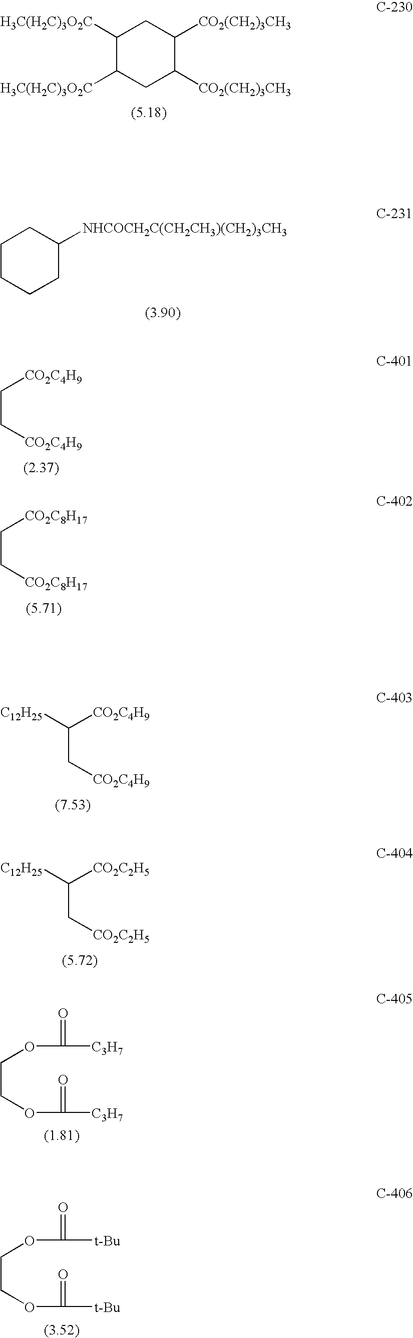

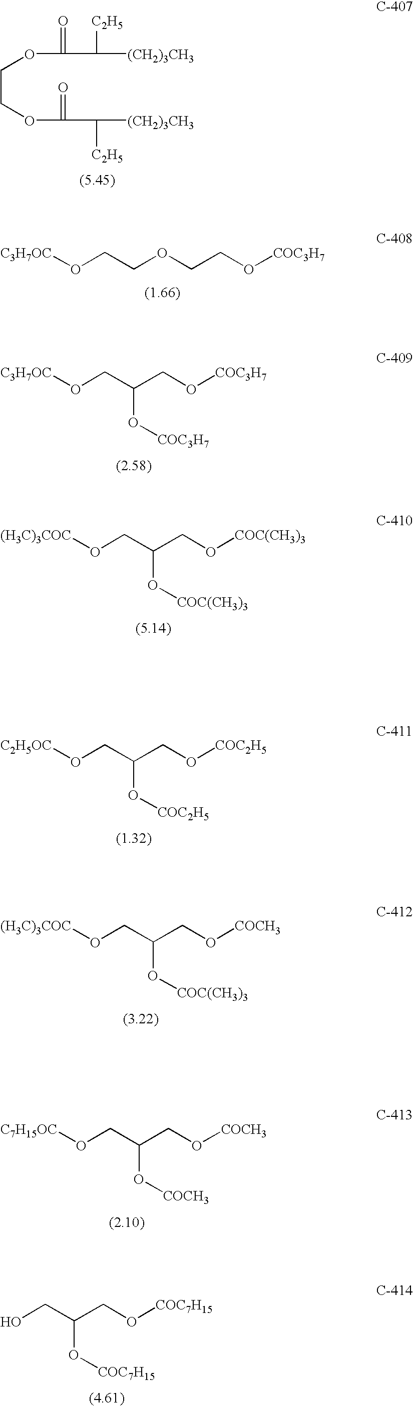

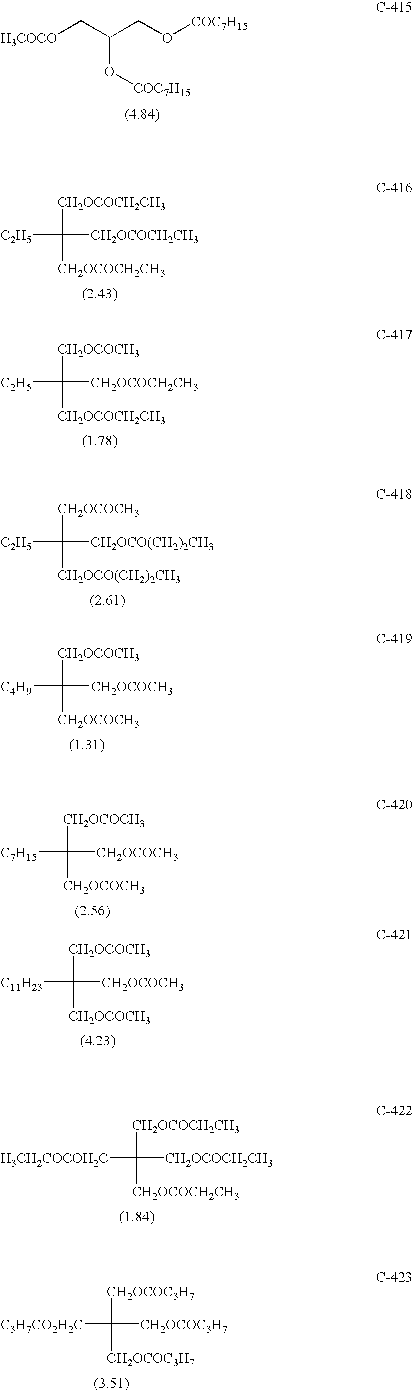

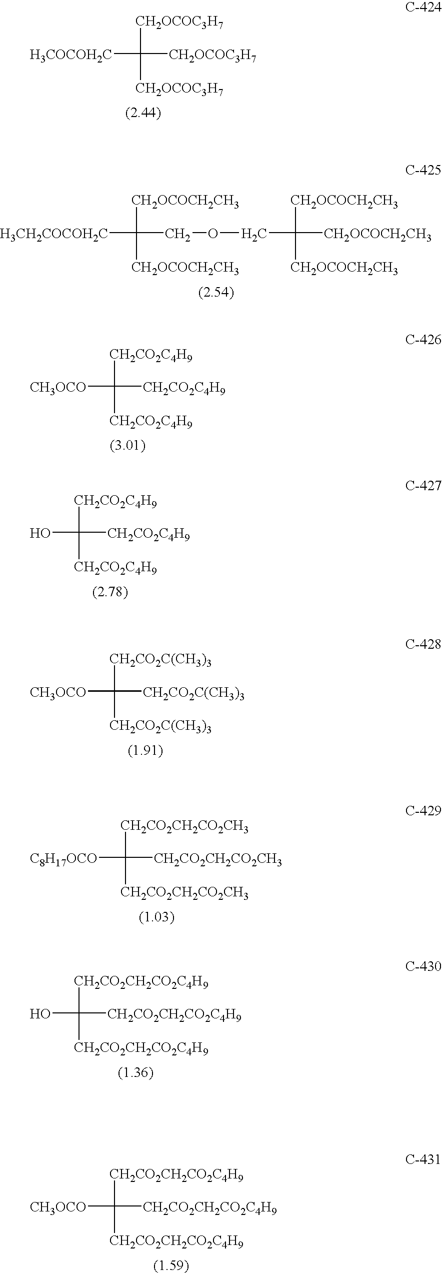

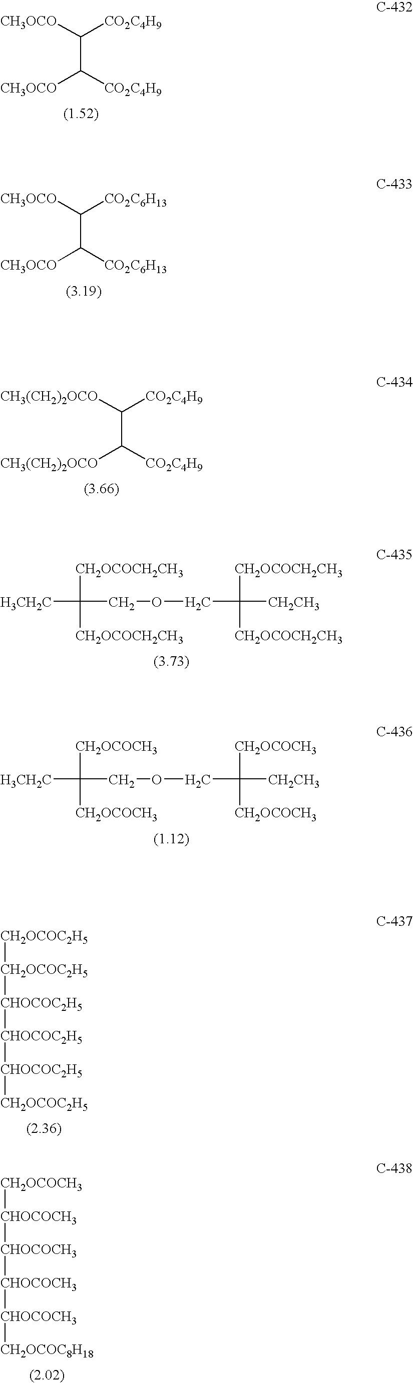

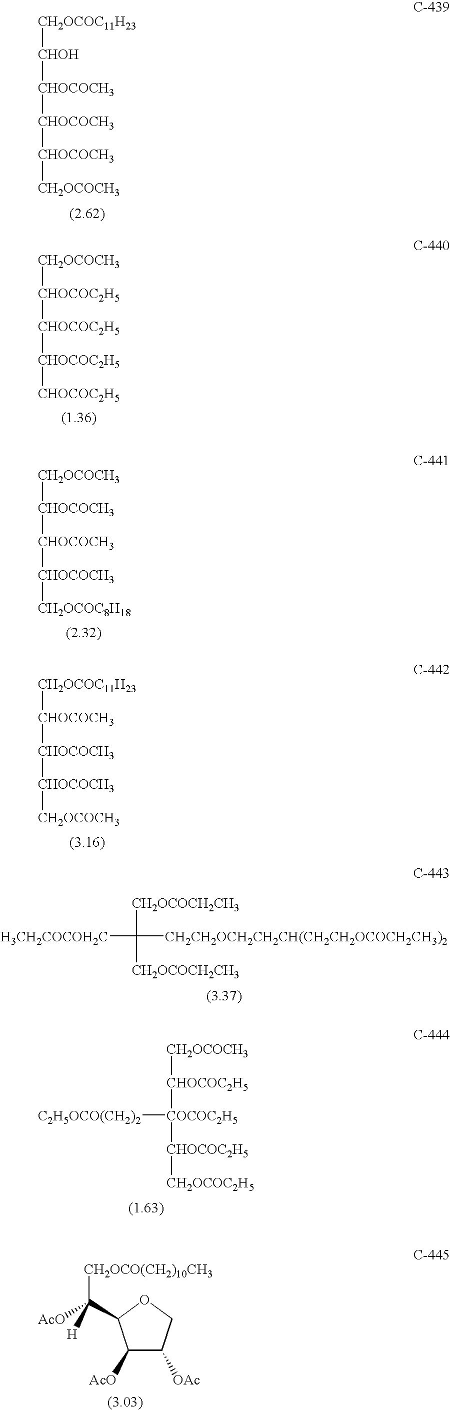

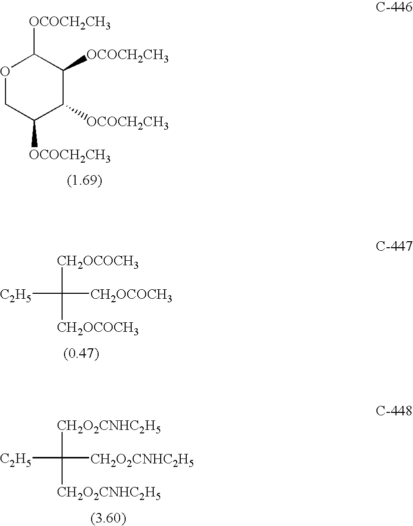

An aliphatic compound represented by the following formula (1) is particularly preferably used in the invention from the points of the reduction of humidity dependency of retardation and the reduction of variation in retardation before and after saponification treatment. A compound represented by formula (1) is described in detail below.

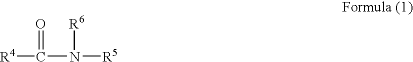

In formula (1), R⁴, R⁵ and R⁶ each independently represents an alkyl group, and each alkyl group may have a substituent.

In formula (1), R⁴, R⁵ and R⁶ each independently represents an alkyl group. The alkyl group may be straight chain, branched or cyclic. R⁴ preferably represents a cyclic alkyl group. It is preferred that at least either R⁵ or R⁶ represents a cyclic alkyl group. The alkyl group preferably has from 1 to 20 carbon atoms, more preferably from 1 to 15, and most preferably from 1 to 12. As the cyclic alkyl group, a cyclohexyl group is especially preferred.

The alkyl group in formula (1) may have a substituent. As the substituents, a halogen atom (e.g., chlorine, bromine, fluorine, iodine), an alkyl group, an alkoxyl group, an acyl group, an alkoxycarbonyl group, an acyloxy group, a sulfonylamino group, a hydroxyl group, a cyano group, an amino group and an acylamino group are preferred, a halogen atom, an alkyl group, an alkoxyl group, a sulfonylamino group, and an acylamino group are more preferred, and an alkyl group, a sulfonylamino group and an acylamino group are especially preferred.

The preferred examples of the compounds represented by formula (1) are shown below, but the invention is not restricted to these examples.

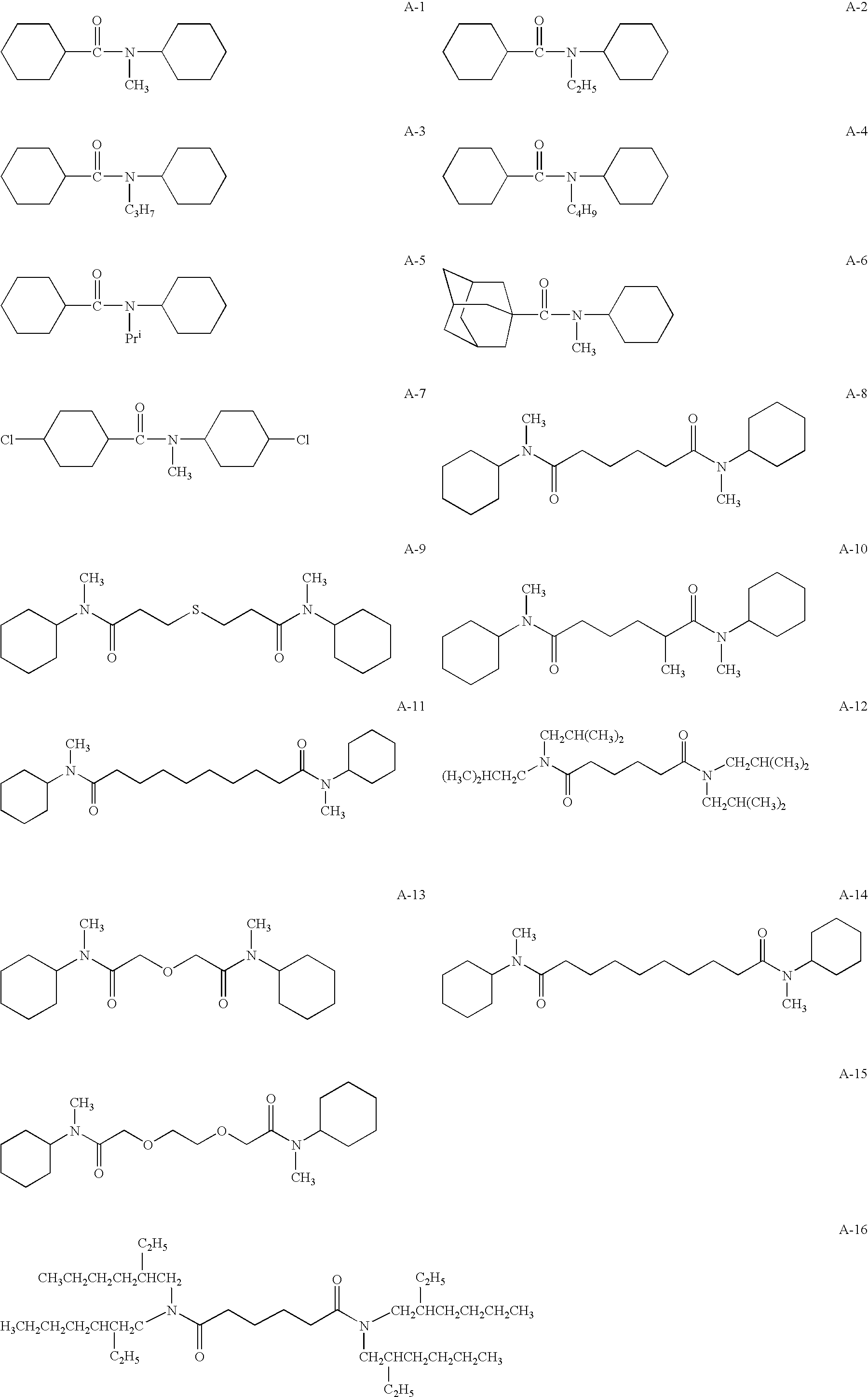

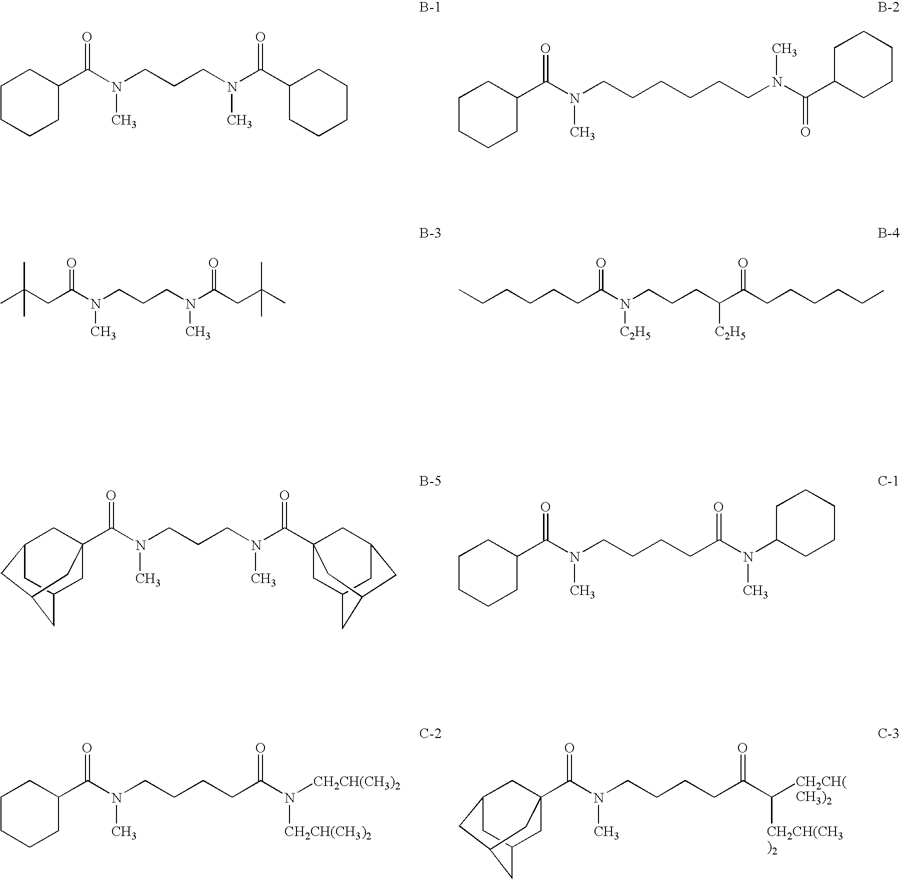

Any of the above compounds can be produced by well-known methods. That is, the compound represented by formula (1) can be obtained by a dehydration condensation reaction of carboxylic acids and amines with a condensing agent (e.g., dicyclohexylcarbodiimide (DCC), etc.), or by a substitution reaction of a carboxylic acid chloride derivative and an amine derivative.

As the aliphatic compound for use in the invention, the compound represented by formula (1) is especially preferably used.

The aliphatic compound in the invention may be dissolved in an alcohol or an organic solvent, e.g., methylene chloride or dioxolan, and then added to a cellulose acetate solution (a dope), or may be directly added to a dope composition.

The content of the aliphatic compound of the invention is from 1 to 30 mass % per 100 mass parts of cellulose acylate, preferably from 2 to 30 mass %, more preferably from 3 to 25 mass %, and most preferably from 5 to 20 mass %. (In this specification, mass ratio is equal to weight ratio.)

In the next place, a producing method of a cellulose acylate film is described in detail

### (Production of Cellulose Acylate Film)

The cellulose acylate film in the invention can be produced according to a solvent casting method. In the solvent casting method, the film is produced with a solution (dope) having an cellulose acylate dissolved in an organic solvent.

The organic solvent preferably includes a solvent selected from an ether having from 3 to 12 carbon atoms, a ketone having from 3 to 12 carbon atoms, an ester having from 3 to 12 carbon atoms, and a halogenated hydrocarbon having from 1 to 6 carbon atoms.

The ether, the ketone and the ester may each have a cyclic structure. A compound containing any two or more of functional groups of the ether, the ketone and the ester (that is, —O—, —CO—, and —COO—) can also be used as the organic solvent. The organic solvent may contain other functional group such as an alcoholic hydroxyl group. In the case of using an organic solvent containing two or more kinds of functional groups, it is preferable that the number of carbon atoms thereof falls within the foregoing preferred range of the number of carbon atoms of the solvent containing any functional group.

The examples of the ethers having from 3 to 12 carbon atoms include diisopropyl ether, dimethoxymethane, dimethoxyethane, 1,4-dioxane, 1,3-dioxolan, tetrahydrofuran, anisole, and phenetole.

The examples of the ketones having from 3 to 12 carbon atoms include acetone, methyl ethyl ketone, diethyl ketone, diisobutyl ketone, cyclohexanone, and methylcyclohexanone.

The examples of the esters having from 3 to 12 carbon atoms include ethyl formate, propyl formate, pentyl formate, methyl acetate, ethyl acetate, and pentyl acetate.

The examples of the organic solvents containing two or more kinds of functional groups include 2-ethoxyethyl acetate, 2-methoxyethanol, and 2-butoxyethanol.

The number of carbon atoms of the halogenated hydrocarbon is preferably 1 or 2, and most preferably 1. The halogen of the halogenated hydrocarbon is preferably chlorine. The proportion of the hydrogen atom of the halogenated hydrocarbon as substituted with the halogen is preferably from 25 to 75 mol %, more preferably from 30 to 70 mol %, still more preferably from 35 to 65 mol %, and most preferably from 40 to 60 mol %. Methylene chloride is a representative halogenated hydrocarbon.

A mixture of two or more kinds of organic solvents can be used.

The cellulose acylate solution can be prepared by a general method including the treatment at a temperature of 0° C. or higher (normal temperature or high temperature). The preparation of the solution can be carried out according to a preparation method of a dope and a device in the usual solvent casting method. Incidentally, in the case of the general method, it is preferred to use a halogenated hydrocarbon (in particular, methylene chloride) as the organic solvent.

The amount of the cellulose acylate is preferably adjusted such that it is contained in an amount of from 10 to 40 mass % in the resulting solution. The amount of the cellulose acylate is more preferably from 10 to 30 mass %. An arbitrary additive as described later may be added in the organic solvent (prime solvent).

The solution can be prepared by stirring the cellulose acylate and the organic solvent at a normal temperature (from 0 to 40° C.). The solution with high concentration may be stirred under a pressurizing and heating condition. Specifically, the cellulose acylate and the organic solvent are put in a pressure vessel, and after closing the vessel, the mixture is stirred under a pressure while heating at a temperature in the range of from the boiling point of the solvent at a normal temperature to a temperature at which the solvent is not boiled. The heating temperature is usually 40° C. or higher, preferably from 60 to 200° C., and more preferably from 80 to 110° C.

The respective components may be previously roughly mixed and then put in the vessel. Alternatively they may be successively put in the vessel. The vessel must be constructed such that stirring can be achieved. The vessel can be pressurized by the injection of inert gas such as nitrogen gas. Further, an increase of the vapor pressure of the solvent due to heating may be utilized. Alternatively, after closing the vessel, the respective components may be added under the application of pressure.

In the case of heating, it is preferable that the heating is carried out from the outside of the vessel. For example, a jacket type heating device can be employed. Further, the whole of the vessel can be heated by providing a plate heater in the outside of the vessel, piping and circulating a liquid.

It is preferred to provide stirring blades in the inside of the vessel and perform stirring with the stirring blades. As the stirring blade, one having a length such that it reaches the vicinity of the wall of the vessel is preferred. It is preferred to provide scraping blades for renewing a liquid film on the wall of the vessel.

The vessel may be equipped with a measuring instrument such as a pressure gauge and a thermometer. The respective components are dissolved in the solvent within the vessel. A prepared dope is cooled and then taken out from the vessel, or is taken out from the vessel and then cooled with a heat exchanger and the like.

The solution can also be prepared by a dissolution method under cooling. According to the dissolution method under cooling, it is possible to dissolve the cellulose acylate even in an organic solvent capable of hardly dissolving the cellulose acylate therein by a usual dissolution method. Incidentally, the dissolution method under cooling has an effect of rapidly obtaining a uniform solution even by using a solvent capable of dissolving the cellulose acylate therein by a usual dissolution method.

In the dissolution method under cooling, first of all, the cellulose acylate is added in an organic solvent at room temperature while stirring step by step. It is preferred to adjust the amount of the cellulose acylate such that the cellulose acylate is contained in an amount of from 10 to 40 mass % in the mixture. The amount of the cellulose acylate is more preferably from 10 to 30 mass %. In addition, an arbitrary additive as described later may be added in the mixture.

In the next place, the mixture is cooled to from −100 to −10° C. (preferably from −80 to −10° C., more preferably from −50 to −20° C., and most preferably from −50 to −30° C.). The cooling can be carried out in, for example, a dry ice-methanol bath (at −75° C.) or a cooled diethylene glycol solution (at from −30 to −20° C.). By cooling, the mixture of the cellulose acylate and the organic solvent is solidified.

The cooling rate is preferably 4° C./min or more, more preferably 8° C./min or more, and most preferably 12° C./min or more. It is preferred that the cooling rate is fast as far as possible. However, 10,000° C./sec is the theoretical least upper bound, 1,000° C./sec is the technical least upper bound, and 100° C./sec is the least upper bound for practical use. Incidentally, the cooling rate is a value obtained by dividing the difference between the temperature at the time of start of cooling and the final cooling temperature by the time required for reaching the final cooling temperature from the start of cooling.

In addition, when the solid is heated to from 0 to 200° C. (preferably from 0 to 150° C., more preferably from 0 to 120° C., and most preferably from 0 to 50° C.), the cellulose acylate is dissolved in the organic solvent. The temperature elevation may be achieved by allowing it to stand at room temperature or by heating in a warm bath. The heating rate is preferably 4° C./min or more, more preferably 8° C./min or more, and most preferably 12° C./min or more. It is preferable that the heating rate is fast as far as possible. However, 10,000° C./sec is the theoretical least upper bound, 1,000° C./sec is the technical least upper bound, and 100° C./sec is the least upper bound for practical use. Incidentally, the heating rate is a value obtained by dividing the difference between the temperature at the time of start of heating and the final heating temperature by the time required for reaching the final heating temperature from the start of heating

In this way, a uniform solution is obtained. Incidentally, in the case where dissolution is insufficient, the cooling or heating operation may be repeated. Whether the dissolution is sufficient or not can be judged only by visual observation of the appearance of the solution.

In the dissolution method under cooling, in order to avoid the incorporation of water content due to dew condensation at the time of cooling, it is desired to use a sealed vessel. Further, in the cooling or heating operation, when pressurization is carried out at the time of cooling or pressure reduction is carried out at the time of heating, the dissolution time can be shortened. In carrying out the pressurization or pressure reduction, it is preferred to use a pressure proof vessel.

Incidentally, in a 20 mass % cellulose acetate solution (acetylation degree: 60.9%, viscosity average polymerization degree: 299) dissolved in methyl acetate by the dissolution method under cooling, according to the measurement by a differential scanning calorimeter (DSC), a pseudo phase transition temperature between a sol state and a gel state is present in the vicinity of 33° C., and the solution becomes in a uniform gel state at a temperature of not higher than this temperature. Accordingly, the solution must be maintained at a temperature of the pseudo phase transition temperature or higher, and preferably at a temperature of the gel phase transition temperature plus 10° C. or so. However, this pseudo phase transition temperature varies depending upon the degree of acetylation, viscosity average polymerization degree and solution concentration of cellulose acetate and the organic solvent to be used.

A cellulose acylate film is produced from the prepared cellulose acylate solution (dope) according to the solvent casting method. It is preferred to add a retardation raising agent to the dope. The dope is cast on a drum or band, and the solvent is vaporized to form the film. It is preferred to adjust the concentration of the dope before casting such that the solids content is from 18 to 35%. It is preferred to finish the surface of the drum or band in a mirror state. It is preferred to cast the dope on a drum or band at a surface temperature of not higher than 10° C.

A drying method in the solvent casting method is described, e.g., in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (tile term “JP-B” as used herein refers to an “examined Japanese patent publication”), JP-B-49-5614, JP-A-60-176834, JP-A-60-203430, and JP-A-62-115035. Drying on the band or drum can be carried out by blowing air or inert gas such as nitrogen.

The resulting film is stripped off from the drum or band and dried by high-temperature air whose temperature is changed successively from 100 to 160° C., whereby the residual solvent can be vaporized. Such a method is described in JP-B-5-17844. According to this method, the time from casting until stripping off can be shortened. In order to carry out this method, it is necessary that the dope be gelled at the surface temperature of the drum or band at the time of casting.

Using the prepared cellulose acylate solution (dope), two or more layers are cast, whereby a film can be formed. In this case, it is preferred to prepare the cellulose acylate film by the solvent casting method. The dope is cast on a drum or bad, and the solvent is vaporized to form a film. It is preferred to adjust the concentration of the dope before casting such that the solids content falls within the range of from 10 to 40 mass %. It is preferred to finish the surface of the drum or band in a mirror state.

In the case of casting a plurality of cellulose acylate solutions of two or more layers, a film may be prepared by casting solutions containing a cellulose acylate respectively from a plurality of casting nozzles capable of casting a plurality of cellulose acylate solutions provided at intervals in the advancing direction of a support while laminating. For example, methods as disclosed in JP-A-61-158414, JP-A-1-122419, and JP-A-11-198285 can be employed. A film can also be formed by casting cellulose acylate solutions from two casting nozzles. For example, methods as disclosed in JP-B-60-27562, JP-A-61-94724, JP-A-61-947245, JP-A-61-104813, JP-A-61-158413, and JP-A-6-134933 can be used. A casting method of a cellulose acylate film by encompassing the flow of a high viscosity cellulose acylate solution with a low viscosity cellulose acylate solution and simultaneously extruding the high viscosity and low viscosity cellulose acylate solutions, as described in JP-A-56-162617, can also be used.

Further, a film can be prepared by a method in which by using two casting nozzles a film as molded on a support from a first casting nozzle is stripped off and second casting is carried out in the side coming into contact with the support surface. For example, a method as described in JP-B-44-20235 can be exemplified.

As the cellulose acylate solutions to be cast, the same solution may be used, or different cellulose acylate solutions may be used. For bringing functions to a plurality of cellulose acylate layers, the cellulose acylate solution suitable for each function may be extruded from the respective casting nozzles. In addition, the cellulose acylate solutions of the invention can be cast at the same time with other functional layers (for example, an adhesive layer, a dye layer, an antistatic layer, an antihalation layer, an ultraviolet absorbing layer, and a polarizing layer).

According a conventional single-layered solution, it is necessary to extrude a high viscosity cellulose acylate solution in high concentration for the purpose of attaining a necessary film thickness. In that case, there often occurred a problem that solids are generated due to poor stability of the cellulose acylate solution to thereby cause spitting or failure of flatness. As a method for overcoming this problem, by casting a plurality of cellulose acylate solutions from casting nozzles, high viscosity solutions can be extruded simultaneously on the support, and not only the flatness is improved and a planar film can be prepared, but also a reduction of drying load can be achieved by using the concentrated cellulose acylate solutions, so that the production speed of a film can be enhanced.

### (Thermal Shrinkage Treatment)

The cellulose acylate film in the invention is formed through a thermal shrinkage treatment process. By the thermal shrinkage treatment, the free volumes among cellulose acylate molecular chains are reduced, and the interaction between the cellulose acylate film and the retardation decreasing agent is increased, as a result, the retention of the retardation decreasing agent can be improved. By using an aliphatic compound not having an aromatic compound as the retardation decreasing agent, the effect of the improvement of the retention of the retardation decreasing agent is especially great and preferred.

Thermal shrinkage treatment can be performed by various methods. In the invention, a method of treating a film at an atmospheric temperature higher than Tg for prescribed time in the state where at least one of the transverse direction and the machine direction of the film is free (not fixed) is used. The content of the residual amount of solvent in a film at the time of initiation of thermal treatment is preferably 30 mass % or less, more preferably 10 mass % or less, and most preferably 5 mass % or less. When thermal treatment is performed with the residual amount of solvent in high content, the crystallization of the film progresses, and unfavorable changes such as the deterioration of brittleness resistance and the increase in haze are caused.

As a method of thermal treatment, a method of drying the film after stripping while regulating the transverse direction with an apparatus such as tenter clip, releasing the film from the regulation of the transverse direction after the content of residual solvent is sufficiently decreased, and passing the film through a high temperature zone higher than Tg in the state where tension is applied only in the machine direction can be especially preferably used.

The processes from casting to post-drying may be performed in an air atmosphere or an inert gas atmosphere such as nitrogen gas. As a winding machine for use in the production of the cellulose acylate film in the invention, generally used winding machines may be used. The cellulose acylate can be wound up by a winding method such as a constant tension method, a constant torque method, a taper tension method, and a program tension control method with a fixed internal stress

### [Stretching Treatment]

Stretching treatment of the cellulose acylate film in the invention can be performed for the purpose of approaching uniform degree of orientation of cellulose acylate in the transverse direction and the machine direction.

The stretching direction of the cellulose acylate film may be any of a transverse direction and a machine direction.

A method for stretching in the transverse direction is disclosed, e.g., in JP-A-62-115035, JP-A-4-152125, JP-A-4-284211, JP-A-4-298310, and JP-A-11-48271. The stretching of film is carried out at the normal temperature or under a heating condition. The heating temperature is preferably not higher than the glass transition temperature of the film. The film can be stretched by treatment in drying, and this is effective particularly when a solvent is left. In the case of stretching in the machine direction, for example, by adjusting the rate of conveyance rollers of the film and making a winding up rate faster than a stripping off rate, the film is stretched. In the case of stretching in the transverse direction, the film can also be stretched by conveying the film while maintaining the width by a tenter and widening the width of the tenter step by step. After drying, the film can also be stretched with a stretching machine (preferably with uniaxial stretching using a long stretching machine). The magnification of film stretching is preferably from 1 to 30%, and more preferably from 1 to 15%.

A degradation-preventing agent (e.g., an antioxidant, a peroxide decomposing agent, a radical inhibitor, a metal inactivating agent, an acid scavenger, and an amine) may be added to the cellulose acylate film in the invention. The degradation-preventing agents are disclosed in JP-A-3-199201, JP-A-5-197073, JP-A-5-194789, JP-A-5-271471, and JP-A-6-107854. The addition amount of the degradation-preventing agent is preferably from 0.01 to 1 mass % of the solution (dope) prepared, and more preferably from 0.01 to 0.2 mass %. When the addition amount is less than 0.01 mass %, an effect of the degradation-preventing agent is not substantially noticed. When the addition amount exceeds 1 mass %, bleed out of the degradation-preventing agent onto the film surface may possibly occur. As especially preferred degradation-preventing agents, butylated hydroxytoluene (BHT) and tribenzylamine (TBA) can be exemplified.

An ultraviolet absorber (UV absorber) may be added to the cellulose acylate film of the invention.

As the ultraviolet absorber, for example, an oxybenzophenone based compound, a benzotriazole based compound, a salicylic acid ester based compound, a benzophenone based compound, a cyano acrylate based compound, and a nickel complex salt based compound can be enumerated. Of these, a benzotriazole based compound which is less in coloration is preferable. Also, an ultraviolet absorber as described in JP-A-10-182621 and JP-A-8-337574 and a high molecular ultraviolet absorber as described in JP-A-6-148430 are preferably used. In the case where the cellulose acylate film of the invention is used as a protective film of a polarizing plate, as the ultraviolet absorber, one having less absorption of visible light having an excellent ability for absorbing ultraviolet rays having a wavelength of not more than 370 nm from the viewpoint of preventing deterioration of a polarizer or a liquid crystal and having less absorption of visible light having a wavelength of 400 nm or more from the viewpoint of liquid crystal display properties is preferable.

Specific examples of the benzotriazole based ultraviolet absorber which is useful in the invention include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazol-2-yl)-6-(linear or side chain decyl)-4-methylphenol, and a mixture of octyl-3-[3-tert-butyl-4-hydroxy-5-(5-chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate. However, it should not be construed that the invention is limited thereto.

Also, commercially available products such as TINUVIN 109, TINUVIN 171, TINUVIN 326, and TINUVIN 328 (all of which are manufactured by Ciba Speciality Chemicals) can be preferably used.

### (Physical Characteristics of Film)

The physical characteristics of the cellulose acylate film of the invention are described.

### [Retardation]

In the present specification, Re (λ) and Rth (λ) represent an in-plane retardation and a retardation in a thickness direction at a wavelength of λ nm, respectively, Re (λ) is measured by making light having a wavelength of λ nm incident into the normal line direction in KOBRA 21ADH (manufactured by Oji Scientific Instruments) Rth (λ) is computed by KOBRA 21 ADH on the basis of retardation values, as measured in three directions in total, of the above Re (λ), a retardation value measured by making light having a wavelength of λ nm incident from a direction inclined by +40° against the normal line direction of the film while making the in-plane slow axis (judged by KOBRA 21ADH) serve as a tilt axis (rotational axis), and a retardation value measured by making light having a wavelength of λ nm incident from a direction inclined by −40° against the normal line direction of the film while making the in-plane slow axis serve as a tilt axis (rotational axis). Here, as the hypothetical values of average refractive index, values described in Polymer Handbook (John Wiley & Sons, Inc.) and various catalogs of optical films can be used. When an average refractive index value is not known, it can be measured by an Abbe's refractometer. Average refractive index values of major optical films are exemplified below: cellulose acylate (1.48), cycloolefin polymer (1.52), polycarbonate (1.59), polymethyl methacrylate (1.49), and polystyrene (1.59). By inputting the hypothetical value of the average refractive index and a film thickness, KOBRA 21ADH computes nx, ny and nz.

Re of the cellulose acylate film in the invention at 25° C. 60% RH satisfies the following equation (A) throughout the wavelength range of from 400 to 700 nm.

0 nm≦Re(λ)≦10 nm (A)

More preferably Re satisfies 0 nm≦Re (λ)≦5 nm, and most preferably 0 nm≦Re (λ)≦3 nm.

Further, Rth of the cellulose acylate film in the invention at 25° C. 60% RH satisfies the following equation (B) throughout the wavelength range of from 400 to 700 nm.

−25 nm≦Rth(λ)≦25 nm (B)

More preferably Rth satisfies −10 nm≦Rth (λ)≦10 nm, and most preferably −5 nm≦Rth (λ)≦5 nm.

By bringing Re and Rth into the above ranges respectively, the cellulose acylate film in the invention shows the effect of capable of reducing contrast variation and tint variation by viewing angle when used as the protective film of a polarizing plate.

The cellulose acylate film in the invention has characteristics 1 to 4 shown below.

### [Retention of Additive Under High Temperature Condition (Characteristic 1)]

The residual rate of the additive in the film after aging at 140° C. for 10 hours of the cellulose acylate film of the invention is 98% or more, and preferably 99% or more. The residual rate is expressed by the equation of [(content of additive in film after aging at 140° C. for 10 hours)/(content of additive in film before aging)]×100.

### [Orientation Coefficients of Main Chain and Carbonyl Group in Cellulose Acylate (Characteristic 2)]

The orientation coefficients of the main chain and the carbonyl group of the cellulose acylate in the cellulose acylate film of the invention satisfy the relationships of the following equations (E) to (H):

0.02≦the orientation coefficient of the main chain in a thickness direction≦0.20 (E)

−0.04≦the orientation coefficient of the main chain in an in-plane direction≦0.10 (F)

−0.10≦the orientation coefficient of the carbonyl group in a thickness direction≦−0.02 (G)

−0.10≦the orientation coefficient of the carbonyl group in an in-plane direction≦0.02 (H)

More preferably,

0.08≦the orientation coefficient of the main chain in a thickness direction≦0.16

−0.01≦the orientation coefficient of the main chain in an in-plane direction≦0.04

−0.08≦the orientation coefficient of the carbonyl group in a thickness direction≦−0.04

−0.04≦the orientation coefficient of the carbonyl group in an in-plane direction≦0.00

An orientation coefficient can be evaluated by finding the ratio of spatial absorption coefficients kx/ky, kx/kz and ky/kz in the machine direction (x), transverse direction (y) and thickness direction (z) respectively by an infrared spectral method. For this purpose, it is necessary to measure infrared absorptions by using rays polarized along the directions of x-axis, y-axis and z-axis, and compute the absorption ratio of each factor. It is most ideal to measure infrared absorptions with rays independently polarized in the directions of x-axis, y-axis and z-axis, but the measurement in the thickness direction of z-axis is actually most difficult. In a polarization ATR method, four absorption spectra in the x-direction, y-direction, xz-direction (including both absorption factors of x-axis and z-axis), and yz-direction (including both absorption factors of y-axis and z-axis) are measured, and absorption coefficients in the x-, y- and z-directions are computed from the measured data.

Four fundamental optical arrangements in the measurement according to a polarization ATR method are shown in Fig. Taking one plane of a sample as x, the other side as y, thickness as z, and, for example, in a biaxially stretched film, taking the machine direction (MD) as x, the direction perpendicular to MD (transverse direction, TD) as y, perpendicularly polarized light (s-polarization, transverse electric, TE) and horizontally polarized light (transverse magnetic, TM) are made incident with a wire grid polarizer against the incident plane formed by incident light and reflected light. At this time, x-axis is made coincident with the direction of TE polarization (TEx, TMx). In the next place, the sample is turned by 90°, i.e., x-axis direction and y-axis direction are replaced, and measurement is performed in the same manner (TEy, TMy). When the obtained four absorption spectra are taken as ATEx, ATMx, ATEy, and ATMy, the following relationships are obtained.

A_{TEx}=αkx

A_{TMx}=βky+γkz

A_{TEy}=αky

A_{TMy}=βkx+γkz

Here, α, β and γ are constants depending upon the incident angle and refractive index, and when the incident angle is 45°, computation is performed as follows. (P. A. Floumoy and W. J. Schaffers, Spectrochimica Acta, 22, 5 (1966), K. Palm, Vib. Spectrosc., 6, 185 (1994) can be referred to.)

$$α = \frac{4 p}{( 1 - p ) \sqrt{( 1 - 2 p )}}$$

$$β = \frac{4 p \sqrt{1 - 2 p}}{{( 1 - p )}^{2}}$$

$$γ = \frac{4 p}{{( 1 - p )}^{2} \sqrt{( 1 - 2 p )}}$$

Here, p=(refractive index of sample)²/(refractive index of prism). From these expressions, spatial absorption coefficients in the machine direction (x), transverse direction (y) and thickness direction (z), kx, ky and kz can be computed

$${k}_{x} = \frac{{A}_{{TE}_{x}}}{α}$$

$${k}_{y} = \frac{{A}_{{TE}_{y}}}{α}$$

$${k}_{z} = \{ ( \frac{{A}_{{TM}_{x}} - {βk}_{y}}{γ} ) + ( \frac{{A}_{{TM}_{y}} - {βk}_{x}}{γ} ) \} / 2$$

From the above, the infrared dichroic ratio is expressed by the followings.

D_{xy}=kₓ/k_{y}

D_{xz}=kₓ/k_{z}

Every sample that is absolutely spatially isotropic and non-oriented has a value of 1.00, however, the numerical value increases with the increase of orientation property.

As other method capable of more quantitative evaluation, there is a uniaxial orientation coefficient (fxy, fxz) and expressed by the following expressions. (P. A. Floumoy and W. J. Schaffers, Spectrochimica Acta, 22, 5 (1966) can be referred to.)

f×y_{—}c=(D×y−1)/(D×y+2)

f×z_{—}c=(D×z−1)/(D×z+2)

f×y=f×y_{—}c·(D₀+2)/(D₀−1)

f×z=f×z_{—}c·(D₀+2)/(D₀−1)

In the above expressions, fxy_c means the orientation coefficient of the carbonyl group in the in-plane direction, and fxz_c means the orientation coefficient of the carbonyl group in the thickness direction. Further, fxy shows the orientation coefficient of the main chain in the in-plane direction, and fxz shows the orientation coefficient of the main chain in the thickness direction.

Here, Do=cot2δ, δ is an angle made by the transition moment vector formed by the vibration of molecule and the axis of molecule. For strict computation, it is necessary to examine the direction of the moment of molecular vibration, but in general, by selecting the vibration mode in parallel with the axis of molecule or perpendicular mode, making them 0° and 90° and performing computation, sufficient data concerning orientation properties can be obtained.

Specifically, computation was performed regarding the ester group on the side chain (C═O expansion and contraction, 1,747 cm−1±10 cm−1) as a vibration mode in the direction perpendicular to the molecular axis (δ=90°). The base line was a straight line connecting the minimum value between 1,800 cm⁻¹ and 1,850 cm⁻¹ and the minimum value between 1,510 cm⁻¹ and 1,550 cm⁻¹.

An infrared dichroic ratio can be measured by attenuation total reflection infrared spectral method (ATR-IR method). As for computing method, J. P. Hobbs, C. S. P. Sung, K. Krishan, and S. Hill, Macromolecules, 16, 193 (1983) can be referred to.

The infrared dichroic ratio is found as follows: first, light is made incident in parallel with the machine direction, the absorbance at the time when the polarized light is perpendicular to the incident plane (ATEx) and the absorbance at the time when the polarized plane is parallel with the incident plane (ATMx) are found, and then ATEy and ATMy are measured similarly by making light incident in parallel with the transverse direction, and the infrared dichroic ratio fxy and fxz can be computed according to the above expression.

Specifically, the measurement is performed by the following measuring conditions of the polarization ATR method.

Measuring instrument: FTS7000 (manufactured by Varian Semiconductor Equipment K.K.)
Prism: germanium
Torque between prism and sample: 30cN·m
Area of jig for suppressing sample against prism:

0.34 cm² (Jig 10567, manufactured by USA Specac Inc.)

Incident angle: 45°
Number of times of reflection: one time
Resolution: 4 cm⁻¹

Computation was performed with the refractive index of a sample as 1.48. Prism (germanium) was made 4.00. Perpendicularly polarized light and horizontally polarized light were made incident with a wire grid polarizer against the incident plane formed by incident light and reflected light on the surface of the sample, and FTIR-ATR spectrum was measured. The measurement was performed with the MD direction as x axis, the perpendicular direction (transverse direction, TD) as y axis, and the thickness direction as z axis. By inserting silicone rubber between the sample and the suppressing jig, adhesion reproducibility was obtained between the sample and the prism.

By bringing the orientation coefficients of the main chain and the carbonyl group in the cellulose acylate film into the above ranges, an effect of capable of decreasing the retardation fluctuation by atmospheric humidity can be obtained.

[Elution of Additive from Film into Saponification Solution (Characteristic 3)]

When the cellulose acylate film of the invention is used as the protective film of a polarizing plate, it is preferred that the surface of the film is hydrophilized by saponification treatment for the purpose of imparting adhesion with the PVA of a polarizer. However, an additive is eluted from the film into the saponification solution by saponification treatment, so that the saponification property of the saponification solution lowers and an insoluble decomposed product is generated in the saponification solution, and the decomposed product adhered on the surface of the film causes facial defects. For reducing these problems, the elution of an additive is preferably as little as possible.

The amount of elution of an additive of the cellulose acylate film in the invention per 100 g of the film is 100 mg or less when the film is immersed in 1 liter of an aqueous solution containing 1.5 mol/liter of sodium hydroxide at 55° C. for 10 minutes, preferably 50 mg or less, and more preferably 10 mg or less.

The elution of an additive can be reduced by making the free volumes among cellulose acylate molecular chains smaller to thereby heighten the interaction between the additive and the cellulose acylate, in addition to the lowering of the solubility of the additive itself to a saponification solution. The producing method of the cellulose acylate film of the invention containing a process of thermal shrinkage treatment is great in an effect of reducing the elution of an additive to a saponification solution and preferred

### [Variation in Retardation of Film Due to Saponification Treatment (Characteristic 4)]

The variation in retardation of the cellulose acylate film of the invention at 25° C., 60% RH before and after the above saponification (immersion in an aqueous solution containing 1.5 mol/liter of sodium hydroxide at 55° C. for 10 minutes) satisfies the relationships of the following equations (C) and (D),

−2 nm≦[(Re before immersion treatment)−(Re after immersion treatment)]≦2 nm (C)

−3 nm≦[(Rth before immersion treatment)−(Rth after immersion treatment)]≦3 nm (D)

in equations (C) and (D), Re and Rth are values at a wavelength of 590 nm.

Equation (C) is more preferably −1 nm≦[(Re before immersion treatment)−(Re after immersion treatment)]≦1 nm.

Equation (D) is more preferably −2 nm≦[(Rth before immersion treatment)−(Rth after immersion treatment)]≦2 nm.

In addition to the above characteristics 1 to 4, it is preferred for the cellulose acylate film in the invention to have the following characteristics.

### [Dimensional Variation]

The dimensional variation of the cellulose acylate film of the invention in MD direction and TD direction before and after aging at 100° C. for 250 hours is preferably from −0.15 to 0.15% respectively, and more preferably from −0.10 to 10%.

The rate of dimensional variation is computed by the following equation.

Rate of dimensional variation=[(dimension after aging at 100° C. for 250 hours)/(dimension before aging)]/(dimension before aging)

### [Humidity Dependency of Retardation]

The difference in Re (590) at 25° C. 80% RH and Re (590) at 25° C. 10% RH of the cellulose acylate film in the invention is preferably from −10 to 10 nm, and more preferably from −5 to 5 nm.

The difference in Rth (590) at 25° C. 80% RH and Rth (590) at 25° C. 10% RH of the cellulose acylate film in the invention is preferably from −30 to 30 nm, and more preferably from −25 to 25 nm.

### [Sonic Speed]

It is preferred that the ratio of the sonic speed in MD and the sonic speed in TD of the cellulose acylate film in the invention satisfies the following equation (I):

1.0<(sonic speed in MD)/(sonic speed in TD)<1.1 (I)

More preferably the ratio satisfies, 1.02<(sonic speed in MD)/(sonic speed in TD)<1.07.

When the ratio of the sonic speed in MD and in TD is in the above range, the dimensional fluctuation of the film due to high temperature aging can be lessened.

Sonic speed was measured with a sonic speed meter SST-110 (manufactured by Nomura Corporation Co., Ltd.).

### [Photoelasticity]

The coefficient of photoelasticity of the cellulose acylate of the invention is preferably not more than 60×10⁻⁸ cm²/N, and more preferably not more than 20×10⁻⁸ cm²/N. The coefficient of photoelasticity can be determined by an ellipsometer.

### [Glass Transition Temperature]

The glass transition temperature (Tg) of the cellulose acylate of the invention is preferably 120° C. or higher, and more preferably 130° C. or higher. The glass transition temperature is determined as an average value of a temperature at which the base line of the film derived from the glass transition begins to change and a temperature at which the film returns to the base line when measured at a temperature rise rate of 10° C./min using a differential scanning calorimeter (DSC)

### [Thickness of Cellulose Acylate Film]

The thickness of the cellulose acylate film in the invention is preferably from 10 to 200 μm, more preferably from 20 to 150 μm, and most preferably from 30 to 100 μm

### [Moisture Content of Cellulose Acylate Film]

The moisture content of the cellulose acylate film in the invention can be evaluated by measuring the equilibrium moisture content at a prescribed temperature and humidity. The equilibrium moisture content is a value obtained by allowing a sample to stand at a prescribed temperature and humidity for 24 hours, measuring the moisture amount of the sample reached equilibrium with Karl Fisher's method, and dividing the moisture amount (g) by the sample mass (g).

The moisture content of the cellulose acylate film in the invention at 25° C. 80% RH is preferably 5.0 mass % or less, more preferably 4.3 mass % or less, and most preferably 3.5 mass % or less.

### (Construction of Polarizing Plate)

Next, the polarizing plate of the invention will be described in detail.

The polarizing plate of the invention may have, as constructional elements, an adhesive layer, a separate film, and a protective film in addition to a polarizer and a protective film.

### (1) Protective Film

The polarizing plate of the invention has two protective films in total on the both sides of a polarizer, and at least one of the two protective films is preferably the cellulose acylate film of the invention. When the polarizing plate of the invention is used in a liquid crystal display device, it is preferable that at least one of two polarizing plates to be disposed on the both sides of a liquid crystal cell is the polarizing plate of the invention.

In the invention, it is preferable that the protective film which is used for the opposite side to the cellulose acylate film of the invention is a polymer film made of a norbornene resin, polyethylene terephthalate, polyethylene naphthalate, polycarbonate, polystyrene, polyallylate, polysulfone, a cellulose acylate, etc. It is the most preferable that the protective film which is used in the invention is a cellulose acylate film.

### (2) Polarizer

The polarizer of the invention is preferably constructed of polyvinyl alcohol (PVA) and a dichroic molecule. A polyvinylene based polarizer obtained by dehydrating or dechlorinating PVA or polyvinyl chloride to form a polyene structure and orienting it as described in JP-A-11-248937 can also be used.

PVA is a polymer raw material resulting from saponification of polyvinyl acetate and may contain a component copolymerizable with vinyl acetate, such as unsaturated carboxylic acids, unsaturated sulfonic acids, olefins, and vinyl ethers. Furthermore, modified PVA containing an acetoactyl group, a sulfonic acid group, a carboxyl group, an oxyalkylene group, etc. can be used.

Though the degree of saponification of PVA is not particularly limited, it is preferably from 80 to 100% by mole, and especially preferably from 90 to 100% by mole from the viewpoints of solubility, etc. Further, though the degree of polymerization of PVA is not particularly limited, it is preferably from 1,000 to 10,000, and especially preferably from 1,500 to 5,000.

As described in Japanese Patent No. 2,978,219, for the purpose of improving the durability, the syndiotacticity of PVA is preferably 55% or more. However, as described in Japanese Patent No. 3,317,494, PVA having a syndiotacticity of from 45 to 52.5% can also be preferably used.

It is preferable that after film formation of PVA, a dichroic molecule is introduced to construct a polarizer. As a method for producing a PVA film, in general, a method in which a stock solution of a PVA based resin dissolved in water or an organic solvent is cast to form a film is preferably employed. The concentration of the polyvinyl alcohol based resin in the stock solution is usually from 5 to 20% by mass. By subjecting this stock solution to film formation by casting method, a PVA film having a film thickness of from 100 to 200 μm can be produced. The production of the PVA film can be carried out by referring to Japanese Patent No. 3,342,516, JP-A-09-328593, JP-A-2001-302817, and JP-A-2002-144401.

Though the crystallinity of the PVA film is not particularly limited, a PVA film having an average crystallinity (Xc) of from 50 to 75% by mass as described in Japanese Patent No 3,251,073 can be used. A PVA film having a crystallinity of not more than 38% as described in JP-A-2002-236214 can also be used for the purpose of reducing in-plane hue scatter.

It is preferable that the birefringence (Δn) of the PVA film is small. A PVA film having a birefringence of not more than 1.0×10⁻³ as described in Japanese Patent No. 3,342,516 can be preferably used. However, as described in JP-A-2002-228835, for the purpose of obtaining a high degree of polarization while avoiding cutting at the time of stretching the PVA film, the birefringence of the PVA film may be regulated at from 0.02 to 0.01; and as described in JP-A-2002-060505, a value of [(nx+ny)/2−nz] may be regulated at from 0.0003 to 001. The retardation (in-plan) of the PVA film is preferably from 0 nm to 100 nm, and more preferably from 0 nm to 50 nm. Furthermore, the Rth (in the film thickness direction) of the PVA film is preferably from 0 nm to 500 nm, and more preferably from 0 nm to 300 nm.

Besides, for the polarizing plate of the invention, a PVA film having a 1,2-glycol binding amount as described in Japanese Patent No. 3,021,494; a PVA film having the number of optical foreign matters of 5 μm or more of not more than 500 per 100 cm² as described in JP-A 2001-316492; a PVA film having an unevenness in hot-water cutting temperature of not more than 1.5° C. in the TD direction of the film as described in JP-A-2002-030163 and a PVA film resulting from further mixing from 1 to 100 parts by mass of a trihydric to hexahydric polyhydric alcohol such as glycerin therewith; and a PVA film resulting from film formation of a solution of PVA having a 15% by mass or more of a plasticizer mixed therewith as described in JP-A-06-289225 can be preferably used.

Though the film thickness of the PVA film before stretching is not particularly limited, it is preferably from 1 μm to 1 mm, and especially preferably from 20 to 200 μm from the viewpoints of stability of film retention and uniformity of stretching. A thin PVA film in which a stress as generated at the time of stretching in water by from 4 to 6 times becomes 10 N or less as described in JP-A-2002-236212 may be used.

As the dichroic molecule, a high-order iodine ion such as I₃⁻ and I₅⁻ or a dichroic dye can be preferably used. In the invention, a high-order iodine ion is especially preferably used. The high-order iodine ion can be formed by dipping PVA in a solution of iodine dissolved in a potassium iodide aqueous solution and/or a boric acid aqueous solution, thereby adsorbing and orienting PVA as described in Henkoban-no-Oyo (Application of Polarizing Plate), edited by Ryo Nagata and published by CMC Publishing Co., Ltd. and Kogyo Zairyo (Industrial Materials), Vol. 28, No. 7, pages 39 to 45.

When a dichroic dye is used as the dichroic molecule, an azo based dye is preferable, and a bisazo based dye and a trisazo based dye are especially preferable. As the dichroic dye, a water-soluble dichroic dye is preferable. For that reason, it is preferred to introduce a hydrophilic substituent (for example, a sulfonic acid group, an amino group, and a hydroxyl group) into the dichroic molecule and use it as a free acid or an alkali metal salt, an ammonium salt or an amine salt.

Specific examples of such a dichroic dye include benzidine based dichroic dyes (for example, C.I. Direct Red 37, Congo Red (C.I. Direct Red 28), C.I. Direct Violet 12, C.I. Direct Blue 90, C.I. Direct Blue 22, C.I. Direct Blue 1, C.I. Direct Blue 151, and C.I. Direct Green 1), diphenylurea based dichroic dyes (for example, C.I. Direct Yellow 44, C.I. Direct Red 23, and C.I. Direct Red 79); stilbene based dichroic dyes (for example, C.I. Direct Yellow 12); dinaphthylamine based dichroic dyes (for example, C.I. Direct Red 31); and J-acid based dichroic dyes (for example, C.I. Direct Red 81, C.I. Direct Violet 9, and C.I. Direct Blue 78).

Besides, C.I. Direct Yellow 8, C.I. Direct Yellow 28, C.I. Direct Yellow 86, C.I. Direct Yellow 87, C.I. Direct Yellow 142, C.I. Direct Orange 26, C.I. Direct Orange 39, C.I. Direct Orange 72, C.I. Direct Orange 106, C.I. Direct Orange 107, C.I. Direct Red 2, C.I. Direct Red 39, C.I. Direct Red 83, C.I. Direct Red 89, C.I. Direct Red 240, C.I. Direct Red 242, C.I. Direct Red 247, C.I. Direct Violet 48, C.I. Direct Violet 51, C.I. Direct Violet 98, C.I. Direct Blue 15, C.I. Direct Blue 67, C.I. Direct Blue 71, C.I. Direct Blue 98, C.I. Direct Blue 168, C.I. Direct Blue 202, C.I. Direct Blue 236, C.I. Direct Blue 249, C.I. Direct Blue 270, C.I. Direct Green 59, C.I. Direct Green 85, C.I. Direct Brown 44, C.I. Direct Brown 106, C.I. Direct Brown 195, C.I. Direct Brown 210, C.I. Direct Brown 223, C.I. Direct Brown 224, C.I. Direct Black 1, C.I. Direct Black 17, C.I. Direct Black 19, C.I. Direct Black 54, and the like; dichroic dyes as described in JP-A-62-70802, JP-A-1-161202, JP-A-1-172906, JP-A-1-172907, JP-A-1-183602, JP-A-1-248105, JP-A-1-265205, and JP-A-7-261024; and the like can also be preferably used. For the purpose of producing a dichroic molecule having a variety of hues, two or more kinds of these dichroic dyes may be blended. When the dichroic dye is used, the adsorption thickness may be 4 μm or more as described in JP-A-2002-082222.

When the content of the subject dichroic molecule in the film is too low, the degree of polarization is low, while when it is too high, the single plate transmittance is lowered. Accordingly, the content of the dichroic molecule in the film is usually adjusted so as to fall within the range of from 0.01% by mass to 5% by mass based on the polyvinyl alcohol based polymer which constructs the matrix of the film.

The film thickness of the polarizer is preferably from 5 μm to 40 μm, and more preferably from 10 μm to 30 μm. It is also preferable that a ratio of the thickness of the polarizer to the thickness of the protective film falls within the range of [0.01≦A (thickness of polarizer)/B (thickness of protective film)≦0.16].

Though the crossing angle between the slow axis of the protective film and the absorption axis of the polarizer may be an arbitrary value, it is preferably parallel or an azimuth of 45±20°.

### (Production Step of Polarizing Plate)

Next, the production step of the polarizing plate of the invention will be described.

The production step of the polarizing plate in the invention is preferably constructed of a swelling step, a dyeing step, a film hardening step, a stretching step, a drying step, a sticking step of protective film, and a drying step after the sticking step. The order of the dyeing step, the film hardening step and the stretching step may be arbitrarily varied, and some steps may be combined and carried out at the same time. Furthermore, water washing can be preferably carried out after the film hardening step as described in Japanese Patent No. 3,331,615.

In the invention, it is especially preferred to successively carry out a swelling step, a dyeing step, a film hardening step, a stretching step, a drying step, a sticking step of protective film, and a drying step after the sticking step in this order. Furthermore, an on-line plane condition inspection step may be provided during or after the foregoing steps.

It is preferable that the swelling step is carried out by using only water. However, as described in JP-A-10-153709, for the purposes of stabilizing the optical performance and avoiding the generation of wrinkles of a base material of the polarizing plate in the production line, the degree of swelling of the base material of the polarizing plate can also be controlled by swelling the base material of the polarizing plate with a boric acid aqueous solution.

Furthermore, the temperature and time of the swelling step can be arbitrarily determined and are preferably from 10° C. to 60° C. and from 5 seconds to 2,000 seconds, respectively.

As the dyeing step, a method as described in JP-A-2002-86554 can be employed. Furthermore, as the dyeing method, not only dipping means but also arbitrary means such as coating or spraying of iodine or a dye solution are employable. Moreover, as described in JP-A-2002-290025, a method for achieving dyeing by controlling the concentration of iodine, the dyeing bath temperature and the stretching magnification in the bath while stirring the solution in the bath.

When a high-order iodine ion is used as the dichroic molecule, in order to obtain a polarizing plate with high contrast, it is preferred to use a solution having iodine dissolved in a potassium iodide aqueous solution in the dyeing step. In this case, it is preferable that the iodine-potassium iodine aqueous solution has an amount of iodine in the range of from 0.05 to 20 g/L, an amount of potassium iodide in the range of from 3 to 200 g/L, and a mass ratio of iodine to potassium iodide in the range of from 1 to 2,000. The dyeing time is preferably from 10 to 1,200 seconds, and the solution temperature is preferably from 10 to 60° C. More preferably, the amount of iodine is from 0.5 to 2 g/L, the amount of potassium iodide is from 30 to 120 g/L, the mass ratio of iodine to potassium iodide is from 30 to 120, the dyeing time of from 30 to 600 seconds, and the solution temperature is from 20 to 50° C.

Furthermore, as described in Japanese Patent No. 3,145,747, a boron based compound such as boric acid and borax may be added in the dyeing solution.

In the film hardening step, it is preferred to contain a crosslinking agent by dipping in a crosslinking agent solution or coating the solution. Furthermore, as described in JP-A-11-52130, the film hardening step can also be dividedly carried out.

As the crosslinking agent, a crosslinking agent as described in U.S. Reissue Pat. No. 232,897 can be used. As described in Japanese Patent No. 3,357,109, for the purpose of improving the dimensional stability, a polyhydric aldehyde can be used as the crosslinking agent. Of these, boric acids are most preferably used. When boric acid is used as the crosslinking agent which is used in the film hardening step, a metal ion may be added in a boric acid-potassium iodide aqueous solution. Zinc chloride is preferable as the metal ion. However, as described in JP-A-2000-35512, a zinc halide such as zinc iodide and a zinc salt such as zinc sulfate and zinc acetate can also be used in place of the zinc chloride.

In the invention, it is preferred to prepare a boric acid-potassium iodide aqueous solution having zinc chloride added thereto and dipping a PVA film therein to achieve film hardening. It is preferable that the amount of boric acid is from 1 to 100 g/L, that the amount of potassium iodide is from 1 to 120 g/L, that the amount of zinc chloride is from 0.01 to 10 g/L, that the film hardening time is from 10 to 1,200 seconds, and that the solution temperature is from 10 to 60° C. More preferably, the amount of the boric acid is from 10 to 80 g/L, the amount of potassium iodide is from 5 to 100 g/L, the amount of zinc chloride is from 0.02 to 8 g/L, the film hardening time is from 30 to 600 seconds, and the solution temperature of from 20 to 50° C.

As the stretching step, a longitudinal uniaxial stretching system as described in U.S. Pat. No. 2,454,515 or a tenter system as described in JP-A-2002-86554 can be preferably employed. The stretching magnification is preferably from 2 times to 12 times, and more preferably from 3 times to 10 times. Furthermore, it can be preferably carried out that the relation among the stretching magnification, the thickness of the raw film and the thickness of the polarizer is regulated at [(thickness of polarizer after sticking the protective film)/(thickness of the raw film)×(total stretching magnification)>0.17] as described in JP-A-2002-040256; and that the relation between the width of the polarizer at the time of leaving a final bath and the width of the polarizer at the time of sticking the protective film is regulated at [0.80≦(width of the polarizer at the time of sticking the protective film)/(width of the polarizer at the time of leaving a final bath)≦0.95] as described in JP-A-2002-040247.

As the drying step, a method which is known by JP-A-2002-86554 can be employed. The temperature range is preferably from 30° C. to 100° C., and the drying time is preferably from 30 seconds to 60 minutes. Furthermore, a thermal treatment in which the discoloration temperature in water is 50° C. or high as described in Japanese Patent No. 3,148,513 and aging in an atmosphere in which the temperature and relative humidity are controlled as described in JP-A-07-325215 and JP-A-07-325218 can also be preferably carried out.

The sticking step of protective film is a step for sticking two protective films on the both surfaces of the foregoing polarizer which has left the drying step. A method in which an adhesive solution is fed immediately before sticking and the polarizer and the protective films are superimposed and stuck by a pair of rollers is preferably employed. Furthermore, as described in JP-A-2001-296426 and JP-A-2002-86554, in order to suppress record groove-like irregularities caused due to stretching of the polarizer, it is preferred to adjust the water content of the polarizer at the time of sticking. In the invention, a water content of from 0.1% to 30% is preferably used.

An adhesive between the polarizer and the protective film is not particularly limited. Examples thereof include PVA based resins (including modified PVAs containing an acetoacetyl group, a sulfonic acid group, a carboxyl group, an oxyalkylene group, etc.) and boron compound aqueous solutions. Of these, PVA based resins are preferable. The thickness of the adhesive layer after drying is preferably from 0.01 to 5 μm, and especially preferably from 0.05 to 3 μm.

Furthermore, in order to improve the adhesive strength between the polarizer and the protective film, it is preferable that the protective film is subjected to a surface treatment and then provided for adhesion. Though the surface treatment method is not particularly limited, examples thereof include known methods such as a saponification method using an alkaline solution and a corona treatment method. Furthermore, after the surface treatment, an easily adhesive layer such as a gelatin undercoating layer may be provided.

The saponification treatment using an alkali solution preferably used for the cellulose acylate film in the invention is described in detail below.

### [Condition of Saponification]

The saponification treatment of the cellulose acylate film in the invention is preferably performed in a cycle of immersing the film surface in an alkali solution, and then neutralizing with an acid solution, washing with water and drying.

As the alkali solution, a potassium hydroxide solution and a sodium hydroxide solution are exemplified, and the normal concentration of hydroxide ion is the range of from 0.05 to 5.0 mol/liter, and preferably the range of from 0.1 to 4.0 mol/liter. The alkali solution temperature is preferably the range of from room temperature to 90° C., and more preferably the range of from 30 to 70° C.

The time of saponification is preferably from 10 seconds to 30 minutes, and more preferably from 30 seconds to 10 minutes.

[Surface Energy of Film after Saponification]

The surface energy of the film after saponification can be found according to a contact angle method, a wetting heat method, and an adsorption method as described in Nure no Kiso to Oyo (The Elements and Applications of Wetting), Realize Advanced Technology Limited (Dec. 10, 1989). In the case of the cellulose acylate film in the invention, a contact angle method is preferably used. Specifically, two kinds of solutions whose surface energies are already known are dripped onto the cellulose acylate film, at the point of intersection of the surface of the droplet and the film surface, the angle containing the droplet is defined as a contact angle of the angle formed by the tangent line drawn on the droplet and the film surface, and the surface energy of the film can be found from the computation. As disclosed in JP-A-2002-267839, the contact angle between the protective film surface and water is preferably 50° or less.

The drying condition after sticking follows a method as disclosed in JP-A-2002-86554, but the temperature range is preferably from 30 to 100° C., and the drying time is preferably from 30 seconds to 60 minutes. It is also preferred to perform aging in an atmosphere in which the temperature and relative humidity are controlled as disclosed in JP-A-07-325220.

With respect to the contents of elements in a polarizer, it is preferred that the contents of iodine, boron, potassium and zinc are from 0.1 to 3.0 g/m², from 0.1 to 5.0 g/m², from 0.1 to 2.00 g/m² and from 0 to 2.00 g/m², respectively. Further, the content of potassium in a polarizer may be 0.2 mass % or less as disclosed in JP-A-2001-166143, and the content of zinc in a polarizer may be from 0.04 to 0.5 mass % as disclosed in JP-A-2000-035512.

As described in Japanese Patent No. 3323255, in order to increase the dimensional stability of a polarizing plate, it is also possible to add and use an organotitanium compound and/or an organozirconium compound in any process of the dyeing process, the stretching process and the film hardening process, to thereby contain at least one compound selected from an organotitanium compound and an organozirconium compound. Further, for the purpose of adjusting the hue of a polarizing plate, a dichroic dye may be added.

### (Characteristics of Polarizing Plate)

### (1) Transmittance and Degree of Polarization

The single plate transmittance of the polarizing plate of the invention is preferably from 42.5% to 49.5%, and more preferably from 42.8% to 49.0%. The degree of polarization as defined by the expression 4 is preferably in the range of from 99.900% to 99.999%, and more preferably from 99.940% to 99.995%. The parallel transmittance is preferably in the range of from 36% to 42%, and the crossed transmittance is preferably in the range of from 0.001% to 0.05%. The dichroic ratio as defined by the following expression 5 is preferably in the range of from 48 to 1,215, and more preferably from 53 to 525.

The foregoing transmittance is defined by the following expression on the basis of JIS Z8701,

T=K∫S(λ)y(λ)τ(λ)dλ

In the foregoing expression, K, S(λ), y(λ), and τ(λ) are as follows. Expression (3)

$$K = \frac{100}{\int S ( λ ) y ( λ ) d λ}$$

S(λ): Spectral distribution of standard light to be used in the color display
y(λ): Color matching function of the XYZ system
τ(λ): Spectral transmittance

The degree of polarization of the polarizing plate in the invention is defined by the following expression (4).

$$Degree of polarization ( \% ) = 100 \times \sqrt{\frac{Parallel transmittance - Crossed transmittance}{Parallel transmittance + Crossed transmittance}} \qquad Expression ( 4 )$$

The dichroic ratio (Rd) of the polarizing plate in the invention is defined by the following expression (5).

$$Dichroic ratio ( Rd ) = \frac{log [ \begin{matrix}\frac{Single plate transmittance}{100} \\ ( 1 - \frac{Degree of polarization}{100} )\end{matrix} ]}{log [ \begin{matrix}\frac{Single plate transmittance}{100} \\ ( 1 + \frac{Degree of polarization}{100} )\end{matrix} ]} \qquad Expression ( 5 )$$

The iodine concentration and single plate transmittance may be in the ranges as described in JP-A-2002-258051.

The parallel transmittance may be less in wavelength dependency as JP-A-2001-083328 and JP-A-2002-022950. When the polarizing plate is disposed in the crossed Nicols configuration, the optical characteristic may be in the range as described in JP-A-2001-091736; and the relation between the parallel transmittance and the crossed transmittance may be in the range as described in JP-A-2002-174728.

As described in JP-A-2002-221618, a standard deviation of the parallel transmittance at every 10 nm of a wavelength of light of from 420 to 700 nm may be not more than 3, and a minimum value of (parallel transmittance)/(crossed transmittance) at every 10 nm of a wavelength of light of from 420 to 700 nm.

It is also preferable that the parallel transmittance and the crossed transmittance at a wavelength of the polarizing plate of 440 nm, the parallel transmittance and the crossed transmittance at a wavelength of the polarizing plate of 550 nm, and the parallel transmittance and the crossed transmittance at a wavelength of the polarizing plate of 610 nm may be in the ranges as described in JP-A-2002-258042 and JP-A-2002-258043.

### (2) Hue

The hue of the polarizing plate of the invention is preferably evaluated by using a lightness index L* and chromaticness indices a* and b* in the L*a*b* colorimetric system as recommended as a CIE uniform perception space.

L*, a* and b* are defined by the following expression 6 by using the foregoing X, Y and Z.

$${L}^{*} = 116 {( Y / {Y}_{0} )}^{\frac{1}{3}} - 16 \\ {a}^{*} = 500 [ {( X / {X}_{0} )}^{\frac{1}{3}} - {( Y / {Y}_{0} )}^{\frac{1}{3}} ] \\ {b}^{*} = 200 [ {( Y / {Y}_{0} )}^{\frac{1}{3}} - {( Z / {Z}_{0} )}^{\frac{1}{3}} ] \qquad Expression ( 6 )$$

In the foregoing expression, X₀, Y₀, and Z₀ each independently represents a tristimulus value of the illumination light source; and in the case of standard light C, X₀=98.072, Y₀=100, and Z₀=118.225, and in the case of standard light D₆₅, X₀=95.045, Y₀=100, and Z₀=108.892.

a* of a single polarizing plate is preferably in the range of from −2.5 to 0.2, and more preferably from −2.0 to 0. b* of a single polarizing plate is preferably in the range of from 1.5 to 5, and more preferably from 2 to 4.5. a* of parallel transmitted light of two polarizing plates is preferably in the range of from −4.0 to 0, and more preferably from −3.5 to −0.5. b* of parallel transmitted light of two polarizing plates is preferably in the range of from 2.0 to 8, and more preferably from 2.5 to 7. a* of crossed transmitted light of two polarizing plates is preferably in the range of from −0.5 to 1.0, and more preferably from 0 to 2. b* of crossed transmitted light of two polarizing plates is preferably in the range of from −2.0 to 2, and more preferably from −1.5 to 0.5.

The hue may be evaluated by the chromaticity coordinates (x, y) as calculated from the foregoing X, Y and Z. For example, it is preferably carried out to make the chromaticity (xₚ, yₚ) of the parallel transmitted light of two polarizing plates and the chromaticity (x_{c}, y_{c}) of the crossed transmitted light of two polarizing plates fall within the ranges as described in JP-A-2002-214436, JP-A-2001-166136, and JP-A-2002-169024, respectively or to make the relation between the hue and the absorbance fall within the range as described in JP-A-2001-311827.

### (3) Viewing Angle Characteristic

In the case where the polarizing plate is disposed in the crossed Nicols configuration and light having a wavelength of 550 nm is made incident, when vertical light is made incident and when light is made incident from the azimuth of 45° against the polarization axis at an angle of 40° against the normal line, it is also preferred to make the transmittance ratio and the xy chromaticity difference fall within the ranges as described in JP-A-2001-166135 and JP-A-2001-166137, respectively. Furthermore, it can be preferably carried out that a ratio (T₆₀/T₀) wherein T₀ represents a light transmittance of a polarizing plate laminate as disposed in the crossed Nicols configuration in the vertical direction and T₆₀ represents a light transmittance in a direction as inclined by 60° from the normal line of the laminate is regulated at not more than 10,000 as described in JP-A-10-068817; that when natural light is made incident into the polarizing plate at an arbitrary angle from the normal line to an angle of elevation of 80°, a difference of transmittance of transmitted light within a wavelength region of 20 m in the wavelength range of its transmission spectrum of from 520 to 640 nm is regulated at not more than 6% as described in JP-A-2002-139625; and that a difference of luminance of transmitted light in an arbitrary place far from the film by 1 cm is regulated at not more than 30% as described in JP-A-08-248201.

### (4) Durability

### (4-1) Wet Heat Durability

It is preferred that in the case of standing in an atmosphere at 60° C. 90% RH for 500 hours, a rate of variation in each of the light transmittance and the degree of polarization before and after standing is 3% or less on the basis of the absolute value as disclosed in JP-A-2001-116922. In particular, it is preferred that a rate of variation in the light transmittance is 2% or less and that a rate of variation in the degree of polarization is 1.0% or less, and more preferably 0.1% or less, on the basis of the absolute value. It is also preferred that after standing at 80° C. 90% RH for 500 hours, the degree of polarization is 95% or more, and the single plate transmittance is 38% or more as disclosed in JP-A-07-077608.

### (4-2) Dry Durability

It is preferable that in the case of standing in a dry atmosphere at 80° C. for 500 hours, a rate of change in each of the light transmittance and the degree of polarization before and after standing is not more than 3% on the basis of the absolute value. In particular, a rate of change in the light transmittance is preferably not more than 2%; and a rate of change in the degree of polarization is preferably not more than 1.0%, and more preferably not more than 0.1% on the basis of the absolute value.

### (4-3) Other Durability

In addition, it can be preferably carried out that after standing at 80° C. for 2 hours, a rate of shrinkage is regulated at not more than 0.5% as described in JP-A-06-167611; that the x value and y value after allowing a polarizing plate laminate as disposed in the crossed Nicols configuration on the both surfaces of a glass plate in an atmosphere at 69° C. for 750 hours are regulated so as to fall within the ranges as described in JP-A-10-068818; and that a change in a spectral intensity ratio at 105 cm⁻¹ and 157 cm⁻¹ by the Raman spectroscopy after standing in an atmosphere at 80° C. and 90% RH for 200 hours is regulated so as to fall within the ranges as described in JP-A-08-094834 and JP-A-09-197127.

### (5) Degree of Orientation

When the degree of orientation of PVA is high, a good polarization performance is obtained. An order parameter value as calculated by a measure such as polarization Raman scattering and polarization FT-IR is preferably in the range of from 0.2 to 1.0. Furthermore, it can be preferably carried out that a difference between a coefficient of orientation of a high molecular segment of the entire amorphous region of the polarizer and a coefficient of orientation (0.75 or more) of the occupied molecule is regulated to be at least 0.15 as described in JP-A-59-133509; and that a coefficient of orientation of the amorphous region of the polarizer is regulated to be from 0.65 to 0.85, or a degree of orientation of a high-order iodine ion such as I₃⁻ and I₅⁻ is regulated to be from 0.8 to 1.0 in terms of an order parameter value as described in JP-A-04-204907.

### (6) Other Characteristics

Also, it can be preferably carried out that when heated at 80° C. for 30 minutes, a shrinkage force in the direction of the absorption axis per unit width is regulated at not more 4.0 N/cm as described in JP-A-2002-006133; that in the case of allowing the polarizing plate to stand under a heating condition at 70° C. for 120 hours, both a rate of dimensional change in the direction of the absorption axis of the polarizing plate and a rate of dimensional change in the direction of the polarization axis of the polarizing plate are regulated to fall within ±0.6% as described in JP-A-2002-236213; and that the water content of the polarizing plate is regulated at not more than 3% by mass as described in JP-A-2002-090546. In addition, it can be preferably carried out that the surface roughness in a direction vertical to the stretching axis is regulated at not more than 0.04 μm on the basis of the centerline average roughness as described in JP-A-2000-249832; that a refractive index no in the direction of the transmitting axis is regulated at more than 1.6 as described in JP-A-10-268294; and that the relation between the thickness of the polarizing plate and the thickness of the protective film is regulated so as to fall within the range as described in JP-A-10-1114111.

### (Functionalization of Polarizing Plate)

The polarizing plate of the invention is preferably used as a viewing angle enlarging film for LCD, a retardation film (for example, a λ/4 plate) to be applied in a reflection type LCD, an antireflection film for improving the visibility of a display, a luminance improving film, or a functionalized polarizing plate complexed with an optical film having a functional layer such as a hard coat layer, a forward scattering layer, and an antiglare layer.

A constructional example of the polarizing plate of the invention complexed with the foregoing functional optical film is shown in FIG. 2. As a protective film in one side of a polarizing plate 5, a functional optical film 3 and a polarizer 2 may be bonded to each other via an adhesive layer, which is not shown (FIG. 2A); and a functional optical film 3 may be bonded to a polarizing plate 5 having protective films 1a, 1b on the both surfaces of a polarizer 2 via an adhesive layer 4 (FIG. 2B). In the former case, an arbitrary transparent protective film may be used for the protective film of the other side. Furthermore, in the polarizing plate of the invention, it is preferable that an optical functional layer is stuck onto the protective film via an adhesive layer, thereby constructing the functional optical film 3 as shown in FIG. 2A. The release strength between the respective layers such as a functional layer and a protective film is regulated as 4.0 N/25 mm or more as described in JP-A-2002-311238. It is preferable that the functional optical film is disposed in the side of a liquid crystal module or in the opposite side to the liquid crystal module, namely the display side or backlight side depending upon a desired function.

The functional optical film which is used upon being complexed with the polarizing plate of the invention will be hereunder described.

### (1) Viewing Angle Enlarging Film

The polarizing plate of the invention can be used in combination with a viewing angle enlarging film as proposed in display modes such as TN (twisted nematic), IPS (in-plane switching), OCB (optically compensatory band), VA (vertically aligned), and ECB (electrically controlled birefringence) modes.

As the viewing angle enlarging film for TN mode, WV films (manufactured by Fuji Photo Film Co., Ltd.) as described in Journal of Printing Science and Technology, Vol. 36, No. 3 (1999), pages 40 to 44, the issue of Monthly Display for August 2002, pages 20 to 24, JP-A-4-229828, JP-A-6-75115, JP-A-6-214116, JP-A-8-50206, etc. are preferably combined and used.

A preferred construction of the viewing angle enlarging film for TN mode is one having an oriented layer and an optically anisotropic layer in this order on the foregoing transparent polymer film. The viewing angle enlarging film may be stuck to the polarizing plate via an adhesive and used. However, it is especially preferable from the viewpoint of realizing a reduction in the thickness that the viewing angle enlarging film is used while serving as one of the protective films of the polarizer as described in SID' 00 Dig., page 551 (2000).

The oriented layer can be provided by a measure such as a rubbing treatment of an organic compound (preferably a polymer), oblique vapor deposition of an inorganic compound, and formation of a layer having micro grooves. In addition, an oriented layer whose orientation function is generated by imparting an electrical field, imparting a magnetic field, or irradiating light is known. However, an oriented layer as formed by a rubbing treatment of a polymer is especially preferable. The rubbing treatment is preferably carried out by rubbing the surface of a polymer layer by paper or a cloth several times in a fixed direction. It is preferable that the absorption axis of the polarizer and the rubbing direction are substantially parallel to each other. With respect to the kind of the polymer to be used in the oriented layer, polyimide, polyvinyl alcohol, a polymerizable group-containing polymer as described in JP-A-9-152509, and the like can be preferably used. The thickness of the oriented layer is preferably from 0.01 to 5 μm, and more preferably from 0.05 to 2 μm.

It is preferable that the optically anisotropic layer contains a liquid crystalline compound. It is especially preferable that the liquid crystalline compound which is used in the invention is a discotic compound (discotic liquid crystal). The discotic liquid crystal molecule has a structure in which a disc-like core segmen such as triphenylene derivatives is present and side chains radially extend therefrom. In order to impart stability with time, it is also preferably carried out to further introduce a group capable of causing reaction by heat, light, etc. Preferred examples of the foregoing discotic liquid crystal are described in JP-A-8-50206.

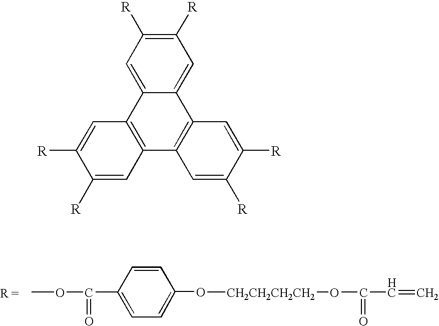

The discotic liquid crystal molecule is oriented substantially parallel to the film plane with a pre-tilt angle against the rubbing direction in the vicinity of the oriented layer, and in the opposite air surface side, the discotic liquid crystal molecule stands up and is oriented in a substantially vertical form against the plane. The whole of the discotic liquid crystal layer takes hybrid orientation, and viewing angle enlargement of TFT-LCD of a TN mode can be realized by this layer structure.

The foregoing optically anisotropic layer is generally obtained by coating a solution of a discotic compound and other compound (additionally, for example, a polymerizable monomer and a photopolymerization initiator) dissolved in a solvent on the oriented layer, drying, heating to the discotic nematic phase forming temperature, polymerizing upon irradiation of UV light or by other means, and then cooling. The discotic nematic liquid crystal phase-solid phase transition temperature of the discotic liquid crystalline compound which is used in the invention is preferably from 70 to 300° C., and especially preferably from 70 to 170° C.

Furthermore, as other compound that the discotic compound to be added in the foregoing optically anisotropic layer, any compound can be used so far as it has compatibility with the discotic compound and can give a preferred change of the tilt angle to the liquid crystalline discotic compound or does not hinder the orientation. Of these, polymerizable monomers (for example, compounds containing a vinyl group, a vinyloxy group, an acryloyl group, or a methacryloyl group), additives for orientation control in the air interface side (for example, fluorine-containing triazine compounds), and polymers (for example, cellulose acetate, cellulose acetate propionate, hydroxypropyl cellulose, and cellulose acetate butyrate) can be enumerated. Such a compound can be generally used in an amount of addition of from 0.1 to 50% by mass, and preferably from 0.1 to 30% by mass to the discotic compound.

The thickness of the optically anisotropic layer is preferably from 0.1 to 10 μm, and more preferably from 0.5 to 5 μm.

A preferred embodiment of the viewing angle enlarging film is constructed of a cellulose acylate film as a transparent base material film, an oriented layer provided thereon, and an optically anisotropic layer made of a discotic liquid crystal as formed on the subject oriented layer, in which the optically anisotropic layer is crosslinked upon irradiation with UV light.

Furthermore, in addition to the above, in the case where the viewing angle enlarging film is combined with the polarizing plate of the invention, for example, it can be preferably carried out that a retardation plate having an optical axis in a direction crossing the plate surface to exhibit anisotropy against birefringence is laminated as described in JP-A-07-198942; and that a range of dimensional change of the protective film is made substantially equal to a rate of dimensional change of the optically anisotropic layer as described in JP-A-2002-258052. Furthermore, it can be preferably carried out that the water content of the polarizing plate to be stuck to the viewing angle enlarging film is regulated at not more than 2.4% as described in JP-A-12-258632, and that the contact angle between the surface of the viewing angle enlarging film and water is regulated at not more than 70° as described in JP-A-2002-267839.

The viewing angle enlarging film for liquid crystal cell of an IPS mode is used for optically compensating the liquid crystal molecule which orients parallel to the base material surface and improving a viewing angle characteristic of the crossed transmittance of the polarizing plate at the time of black display in the state that no electrical field is applied. In the IPS mode, black display is revealed in the state that no electrical field is applied, and the transmission axes of a pair of upper and lower polarizing plates are crossed to each other. However, when observed obliquely, the crossed angle of the transmission axes is not 90°, and light leakage is generated, resulting in a lowering of the contrast. When the polarizing plate of the invention is used in a liquid crystal cell of an IPS mode, for the purpose of lowering the light leakage, it is preferably used in combination with a viewing angle enlarging film having an in-plane retardation close to 0 and having retardation in the thickness direction as described in JP-A-10-54982.

The viewing angle enlarging film for liquid crystal cell of an OCB mode is used for optically compensating the liquid crystal molecule which orients vertically in the center of the liquid crystal layer by the application of an electrical field and orients obliquely in the vicinity of the interface of the base material and improve a viewing angle characteristic of black display. When the polarizing plate of the invention is used in a liquid crystal cell of an OCB mode, it is preferably used in combination with a viewing angle enlarging film in which a disc-like liquid crystalline compound is subjected to hybrid orientation as described in U.S. Pat. No. 5,805,253.

The viewing angle enlarging film for liquid crystal cell of a VA mode improves a viewing angle characteristic of black display in the state that the liquid crystal molecule orients vertically to the base material surface in the state that no electrical field is applied. Such a viewing angle enlarging film is preferably used in combination with a film having an in-plane retardation close to 0 and having retardation in the thickness direction as described in U.S. Pat. No. 2,866,372, a film in which a disc-like compound orients parallel to the base material, a film in which stretched films having the same in-plane retardation value are laminated and disposed such that the slow axes are crossed to each other, or a laminate of films made of a rod-like compound such as a liquid crystal molecule for the purpose of preventing deterioration of the crossed transmittance of the polarizing plate in the oblique direction.

### (2) Retardation Film

It is preferable that the polarizing plate of the invention has a retardation layer. As the retardation layer in the invention, a λ/4 plate is preferable, and when the polarizing plate of the invention is laminated with a λ/4 plate, it can be used as a circularly polarizing plate. The circularly polarizing plate has a function to convert the incident light into circularly polarized light and is preferably utilized in a reflection type liquid crystal display device, a semi-transmission type liquid crystal display device such as ECB mode, or an organic EL element.

In order to obtain substantially complete circularly polarized light in the wavelength range of visible light, it is preferable that the λ/4 plate which is used in the invention is a retardation film having a retardation (Re) of substantially ¼ of the wavelength in the wavelength range of visible light. The “retardation of substantially ¼ of the wavelength in the wavelength range of visible light” means a range which meets the relation in which in the wavelength of from 400 to 700 nm, the longer the wavelength, the larger the retardation is, a retardation value as measured at a wavelength of 450 nm (Re450) is from 80 to 125 nm, and a retardation value as measured at a wavelength of 590 nm (Re590) is from 120 to 160 nm. [(Re590−R450)≧5 nm] is more preferable, and [(Re590−R450)≧10 nm] is especially preferable.

The λ/4 plate which is used in the invention is not particularly limited so far as it meets the foregoing condition. Examples thereof include known λ/4 plates such as λ/4 plates resulting from laminating plural polymer films as described in JP-A-5-27118, JP-A-10-68816, and JP-A-10-90521; λ/4 plates resulting from stretching a single polymer film as described in WO 00/65384 and WO 00/26705; and λ/4 plates having at least one optically anisotropic layer on a polymer film as described in JP-A-2000-284126 and JP-A-2002-31717. Furthermore, the direction of the slow axis of the polymer film and the orientation direction of the optically anisotropic layer can be disposed in an arbitrary direction adaptive with the liquid crystal cell.

In the circularly polarizing plate, though the slow axis of the λ/4 plate and the transmission axis of the foregoing polarizer can be crossed to each other at an arbitrary angle, they are preferably crossed to each other at an angle within the range of 45°±20°. However, the slow axis of the λ/4 plate and the transmission axis of the foregoing polarizer may be crossed to each other at an angle outside the foregoing range.

When the λ/4 plate is constructed by laminating a λ/4 plate and a λ/2 plate, it is preferred to stick the both plates in such a manner that an angle between the in-plane slow axes of the λ/4 plate and the λ/2 plate and the transmission axis of the polarizing plate is 75° and 15°, respectively.

### (3) Antireflection Film

The polarizing plate of the invention can be used in combination with an antireflection film. As the antireflection film, any of a film having a reflectance of about 1.5%, in which only a single layer made of a low refractive index raw material such as a fluorine based polymer is imparted or a film having a reflectance of not more than 1% utilizing multilayered interference of a thin film can be used. In the invention, a construction comprising a transparent support having laminated thereon a low refractive index layer and at least one layer having a refractive index higher than the low refractive index layer (namely, a high refractive index layer and a middle refractive index layer) is preferably used. Antireflection films as described in Nitto Giho, Vol. 38, No. 1, May 2000, pages 26 to 28 and JP-A-2002-301783 can also be preferably used.

The refractive index of each of the layers meets the following relation.

(Refractive index of high refractive index layer)>(Refractive index of middle refractive index layer)>(Refractive index of transparent support)>(Refractive index of low refractive index layer)

As the transparent support to be used in the antireflection film, a transparent polymer film which is used in the protective film of the foregoing polarizer can be preferably used.

The refractive index of the low refractive index layer is from 1.20 to 1.55, and preferably from 1.30 to 1.50. The low refractive index layer is preferably used as an outermost layer having scratch resistance or antifouling properties. For the purpose of improving the scratch resistance, it is preferably carried out to impart slipperiness to the surface by using a raw material containing a silicone group or fluorine.

As the fluorine-containing compound, for example, compounds as described in JP-A-9-222503, paragraphs [0018] to [0026]; JP-A-11-38202, paragraphs [0019] to [0030]; JP-A-2001-40284, paragraphs [0027] to [0028]; and JP-A-2000-284102 can be preferably used.

The silicone-containing compound is preferably a compound having a polysiloxane structure, and useful examples thereof include reactive silicones (for example, SILAPLANE (manufactured by Chisso Corporation) and polysiloxanes containing a silanol group on the both terminals thereof (JP-A-11-258403). An organometallic compound such as silane coupling agents and a silane coupling agent containing a specific fluorine-containing hydrocarbon group may be cured by a condensation reaction in the presence of a catalyst (for example, compounds as described in JP-A-58-142958, JP-A-58-147483, JP-A-58-147484, JP-A-9-157582, JP-A-11-106704, JP-A-2000-117902, JP-A-2001-48590, and JP-A-2002-53804).

In the low refractive index layer, a filler (for example, a low refractive index inorganic compound having an average primary particle size of from 1 to 150 nm such as silicon dioxide (silica) and fluorine-containing particles (for example, magnesium fluoride, potassium fluoride, and barium fluoride), and organic fine particles as described in JP-A-11-3820, paragraphs [0020] to [0038]), a silane coupling agent, a lubricant, a surfactant, and the like can be preferably contained as additives other than the foregoing compounds.

Though the low refractive index layer may be formed by a vapor phase method (for example, a vacuum vapor deposition method, a sputtering method, an ion plating method, and a plasma CVD method), it is preferable from the standpoint of cheap production costs that the low refractive index layer is formed by a coating method. As the coating method, a dip coating method, an air knife coating method, a curtain coating method, a roller coating method, a wire bar coating method, a gravure coating method, and a micro gravure method can be preferably employed.

The film thickness of the low refractive index layer is preferably from 30 to 200 nm, more preferably from 50 to 150 nm, and most preferably from 60 to 120 nm.

It is preferable that the middle refractive index layer and the high refractive index layer are each constructed by dispersing a high refractive index inorganic compound superfine particle having an average particle size of not more than 100 nm in a matrix material. As the high refractive index inorganic compound superfine particle, an inorganic compound having a refractive index of 1.65 or more, such as oxides of Ti, Zn, Sb, Sn, Zr, Ce, Ta, La, In, etc. and composite oxides containing such a metal atom, can be preferably used.

Such a superfine particle can be used in an embodiment such as an embodiment of treating the particle surface with a surface treating agent (for example, silane coupling agents as described in JP-A-11-295503, JP-A-11-153703, and JP-A-2000-9908; and anionic compounds or organometallic coupling agents as described in JP-A-2001-310432), an embodiment of taking a core-shell structure using the high refractive index particle as a core (as described in JP-A-2000-166104), and an embodiment of jointly using a specific dispersant (as described in, for example, JP-A-11-153703, U.S. Pat. No. 6,210,858B1, and JP-A-2002-2776069).

As the matrix material, conventionally known thermoplastic resins and curable resin films and the like can be used. Polyfunctional materials as described in JP-A-2000-47004, JP-A-2001-315242, JP-A-2001-31871, JP-A-2001-296401, etc.; and curable films obtained from a metal alkoxide composition as described in JP-A-2001-293818, etc. can also be used.

The refractive index of the high refractive index layer is preferably from 1.70 to 2.20. The thickness of the high refractive index layer is preferably from 5 nm to 10 μm, and more preferably from 10 nm to 1 μm.

The refractive index of the middle refractive index is adjusted such that it is a value between the refractive index of the low refractive index layer and the refractive index of the high refractive index layer. The refractive index of the middle refractive index is preferably from 1.50 to 1.70.

The haze of the antireflection film is preferably not more than 5%, and more preferably not more 3%. Furthermore, the strength of the film is preferably H or more, more preferably 2H or more, and most preferably 3H or more by a pencil hardness test according to JIS K5400.

### (4) Luminance Improving Film

The polarizing plate of the invention can be used in combination with a luminance improving film. The luminance improving film has a function to separate circularly polarized light or linearly polarized light, is disposed between the polarizing plate and the backlight, and backwardly reflects or backwardly scatters the one-sided circularly polarized light or linearly polarized light. When the light having been again reflected from the backlight part partially changes the polarization state and comes again into the luminance improving film and the polarizing plate, it is partially transmitted. Thus, by repeating this process, the rate of use of light is improved, and the front luminance is improved by about 1.4 times. As the luminance improving film, an anisotropic reflection system and an anisotropic scattering system are known, and all of them can be combined with the polarizing plate of the invention.

With respect to the anisotropic reflection system, a luminance improving film in which a uniaxially stretched film and an unstretched film are laminated in a multiple manner to make a difference in the refractive index in the stretching direction large, thereby having anisotropy of the reflectance and transmittance is known. There are known a multilayered film system using the principle of a dielectric mirror (as described in WO 95/17691, WO 95/17692, and WO 95/17699) and a cholesteric liquid crystal system (as described in European Patent No. 606,940A2 and JP-A-8-271731). In the invention, DBEF-E, DBEF-D and DBEF-M (all of which are manufactured by 3M) can be preferably used as the luminance improving film of a multilayered system using the principle of a dielectric mirror, and NIPOCS (manufactured by Nitto Denko Corporation) can be preferably used as the luminance improving film of a cholesteric liquid crystal system. With respect to NIPOCS, Nitto Giho, Vol. 38, No. 1, May 2000, pages 19 to 21 and the like can be made herein by reference.

Furthermore, it is preferred to use the polarizing plate of the invention in combination with a luminance improving film of an anisotropic scattering system obtained by blending a positive intrinsic birefringent polymer and a negative intrinsic birefringent polymer and uniaxially stretching the blend as described in WO 97/32223, WO 97/32224, WO 97/32225, WO 97/32226, JP-A-9-274108, and JP-A-11-174231. As the luminance improving film of an anisotropic scattering system, DRPF-H (manufactured by 3M) is preferable.

It is preferable that the polarizing plate of the invention and the luminance improving film are used in an embodiment in which the both are stuck to each other via an adhesive or in an integrated body in which the one-sided protective film of the polarizing plate is made to serve as the luminance improving film.

### (5) Other Functional Optical Film

It is also preferable that the polarizing plate of the invention is used in additional combination with a functional optical film provided with a hard coat layer, a forward scattering layer, an antiglare layer, a gas barrier layer, a lubricating layer, an antistatic layer, an undercoating layer, a protective layer, etc. Furthermore, it is also preferred to use such a functional layer mutually complexed with the antireflection layer in the foregoing antireflection film or the optically anisotropic layer or the like in the viewing angle compensating film within the same layer. Such a functional layer can be provided on either one surface or the both surfaces of the polarizer side and the opposite surface to the polarizer (the surface closer to the air side) and used.

### (5-1) Hard Coat Layer

In order to impart a dynamic strength such as scratch resistance, it is preferably carried out that the polarizing plate of the invention is combined with a functional optical film having a hard coat layer provided on the surface of the transparent support. When the hard coat layer is applied to the foregoing antireflection film and used, it is especially preferred to provide the hard coat layer between the transparent support and the high refractive index layer.

It is preferable that the hard coat layer is formed by a crosslinking reaction of a curable compound by light and/or heat or a polymerization reaction. As a curable functional group, a photopolymerizable functional group is preferable, and as a hydrolyzable functional group-containing organometallic compound, an organic alkoxysilyl compound is preferable. As a specific constructional composition of the hard coat layer, ones described in, for example, JP-A-2002-144913, JP-A-2000-9908, and WO 0/46617 can be preferably used.

The film thickness of the hard coat layer is preferably from 0.2 to 100 μm.

The strength of the hard coat layer is preferably H or more, more preferably 2H or more, and most preferably 3H or more by a pencil hardness test according to JIS K5400. Furthermore, it is preferable that the amount of abrasion of a specimen before and after the test in the Taber test according to JIS K5400 is small as far as possible.

As a material for forming the hard coat layer, an ethylenically unsaturated group-containing compound and a ring opening polymerizable group-containing compound can be used. These compounds can be used alone or in combination. Preferred examples of the ethylenically unsaturated group-containing compound include polyacrylates of a polyol (for example, ethylene glycol diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexa-acrylate); epoxy acrylates (for example, diacrylate of bisphenol A diglycidyl ether and diacrylate of hexanediol diglycidyl ether); and urethane acrylates obtained by a reaction of a polyisocyanate and a hydroxyl group-containing acrylate such as hydroxyethyl acrylate. Furthermore, EB-600, EB-40, EB-140, EB-1150, EB-1290K, IRR214, EB-2220, TMPTA, and TMPTMA (all of which are manufactured by Daicel-UCB Company, Ltd.); UV-6300 and UV-1700B (all of which are manufactured by Nippon Synthetic Chemical Industry Co., Ltd.); and the like are enumerated as commercially available products.

Furthermore, preferred examples of the ring opening polymerizable group-containing compound include glycidyl ethers (for example, ethylene glycol diglycidyl ether, bisphenol A diglycidyl ether, trimethylolethane triglycidyl ether, trimethylolpropane triglycidyl ether, glycerol triglycidyl ether, triglycidyl trishydroxyethyl cyanurate, sorbitol tetraglycidyl ether, pentaerythritol tetraglycidyl ether, polyglycidyl ether of a cresol novolak resin, and polyglycidyl ether of a phenol novolak resin); alicyclic epoxys (for example, CELLOXIDE 2021P, CELLOXIDE 2081, EPOLEAD GT-301, EPOLEAD GT-401, and EHPE3150CE (all of which are manufactured by Daicel Chemical Industries, Ltd.), and polycyclohexyl epoxy methyl ether of a phenol novolak resin); and oxetanes (for example, OXT-121, OXT-221, OX-SQ, and PNOX-1009 (all of which are manufactured by Toagosei Co., Ltd.)). Besides, polymers of glycidyl (meth)acrylate or copolymers of glycidyl (meth)acrylate and a copolymerizable monomer can be used in the hard coat layer.

For the purposes of lowering hardening and shrinkage of the hard coat layer, improving adhesion to a base material, and lowering curl of a hard coat-treated article of the invention, it is preferably carried out that a crosslinked fine particle such as an oxide fine particle of silicon, titanium, zirconium, aluminum, etc. and an organic fine particle (for example, a crosslinked particles of polyethylene, polystyrene, a poly(meth)acrylic acid ester, polydimethylsiloxane, etc. and a crosslinked rubber fine particle of SBR, NBR, etc.) is added in the hard coat layer. The average particle size of such a crosslinked fine particle is preferably from 1 nm to 20,000 nm. Furthermore, the crosslinked fine particle is not particularly limited with respect to its shape, and examples of the shape include spherical, rod-like, acicular, and tabular shapes. The amount of addition of the fine particle is preferably not more than 60% by volume, and more preferably not more than 40% by volume of the hard coat layer after hardening.

In the case where the foregoing inorganic fine particle is added, since the inorganic fine particle is in general poor in compatibility with a binder polymer, it is preferably carried out that the inorganic fine particle is subjected to a surface treatment with a surface treating agent containing a metal such as silicon, aluminum, and titanium and having a functional group such as an alkoxide group, a carboxyl group, a sulfonic acid group, and a phosphonic acid group.

It is preferable that the hard coat layer is hardened using heat or active energy rays. Above all, it is more preferred to use active energy rays such as radiations, gamma rays, alpha rays, electron beams, and ultraviolet rays. Taking into account the stability and productivity, it is especially preferred to use electron beams or ultraviolet rays. In the case of performing hardening by heat, taking into account the heat resistance of the plastic itself, the heating temperature is preferably not higher than 140° C., and more preferably not higher than 100° C.

### (5-2) Forward Scattering Layer

The forward scattering layer is used for improving the viewing angle characteristic in the up and down and right and left directions (hue and luminance distribution) in applying the polarizing plate of the invention in a liquid crystal display device. In the invention, a construction in which fine particles having a different refractive index are dispersed in a binder is preferable. For example, a construction in which a coefficient of forward scattering is specified as described in JP-A-11-38208; a construction in which a relative refractive index between a transparent resin and a fine particle is made to fall within a specified range as described in JP-A-2000-199809; and a construction in which the haze value is specified at 40% or more as described in JP-A-2002-107512 can be employed. For the purpose of controlling the viewing angle characteristic of haze, the polarizing plate of the invention can also be preferably combined with “LUMISTRY” as described on pages 31 to 39 of Technical Report “Photo-functional Films” of Sumitomo Chemical Co., Ltd. and used.

### (5-3) Antiglare Layer

The antiglare layer is used for the purpose of scattering reflected light to prevent glare. An antiglare function is obtained by forming irregularities on the most superficial surface (display side) of the liquid crystal display device. The haze of an optical film having an antiglare function is preferably from 3 to 30%, more preferably from 5 to 20%, and most preferably from 7 to 20%.

As a method for forming irregularities on the film surface, for example, a method for adding a fine particle to form irregularities on the film surface (see, for example, JP-A-2000-271878); a method for adding a small amount (from 0.1 to 50% by mass) of a relatively large particle (particle size: 0.05 to 2 μm) to form a film having an irregular surface (see, for example, JP-A-2000-281410, JP-A-2000-95893, JP-A-2001-100004, and JP-A-2001-281407); a method for physically transferring an irregular shape onto the film surface (for example, an embossing method as described in JP-A-63-278839, JP-A-11-183710, and JP-A-2000-275401); and the like can be preferably employed.

### (Liquid Crystal Display Device Using Polarizing Plate)

A liquid crystal display device in which a polarizing plate in the invention is used is described.

In a liquid crystal display device comprising a liquid crystal cell and two polarizing plates arranged on both sides thereof, at least one polarizing plate is the polarizing plate according to the invention.

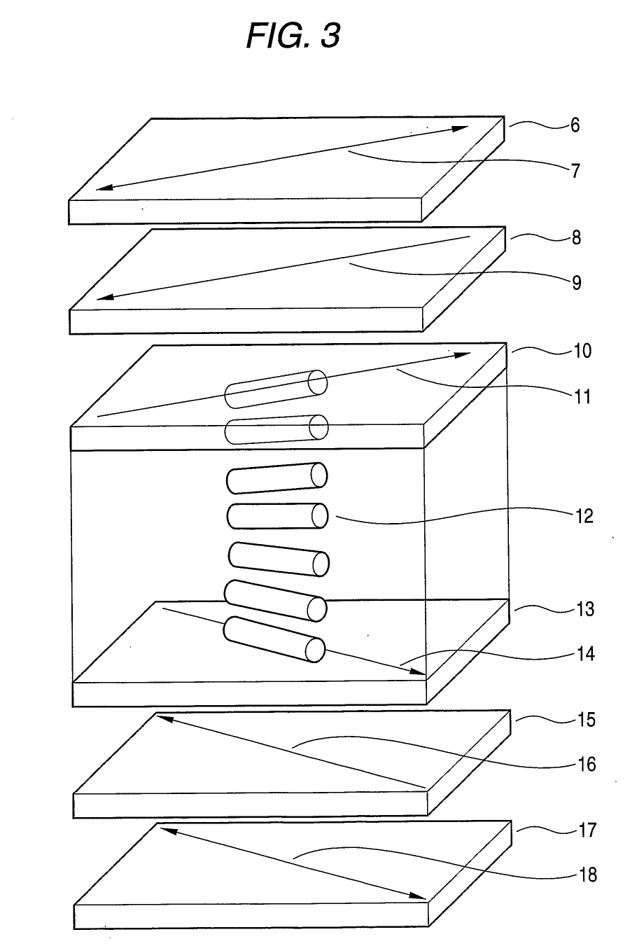

FIG. 3 is an example of a liquid crystal display device in which the polarizing plate according to the invention is used.

The liquid crystal display device as illustrated in FIG. 3 has a liquid crystal cell (10 to 13) and an upper polarizing plate 6 and a lower polarizing plate 17 disposed so as to interpose the liquid crystal cell (10 to 13) therebetween. Though the polarizing plate is interposed by a polarizer and a pair of transparent protective films, in FIG. 3, the polarizing plate is shown as an integrated polarizing plate, and a detail structure is omitted. The liquid crystal cell is composed of a liquid crystal layer which is formed of an upper substrate 10 and a lower substrate 13 and a liquid crystal molecule 12 as interposed therebetween. The liquid crystal cell is classified into various display modes such as TN (twisted nematic), IPS (in-plane switching), OCB (optically compensatory band), VA (vertically aligned), and ECB (electrically controlled birefringence) modes depending upon a difference in the orientation state of the liquid crystal molecule which performs an ON/OFF display. The polarizing plate of the invention can be used in any display mode regardless of the transmission type or reflection type.

Of these display modes, OCB mode or VA mode is preferred.

An oriented film (not shown) is formed on the surface of each of the substrates 10 and 13 coming into contact with the liquid crystal molecule 12 (hereinafter sometimes referred to as “inner surface”), and the orientation of the liquid crystal molecule 12 in the state that no electrical field is applied or in the state that a low electrical field is applied is controlled by a rubbing treatment as applied on the oriented film or the like. Furthermore, a transparent electrode (not shown) capable of applying an electrical field to the liquid crystal layer composed of the liquid crystal molecule 12 is formed on the inner surface of each of the substrates 10 and 13.

Rubbing of a TN mode is applied in such a manner that the rubbing directions are crossed to each other on the upper and lower substrates, and the size of a tilt angle can be controlled by the strength and number of rubbing. The oriented film is formed by coating a polyimide film and then baking it. The size of a twist angle of the liquid crystal layer is determined by a crossing angle in the rubbing directions on the upper and lower substrates and a chiral agent to be added to a liquid crystal material. In order that the twist angle may become 90°, a chiral agent having a pitch of about 60 μm is added.

Incidentally, the twist angle is set up in the vicinity of 90° (from 85 to 95°) in the case of monitors of notebook PC and PC and liquid crystal display devices for TV and is set up at from 0 to 70° in the case of use as a reflection type display device such as mobile telephones. Furthermore, in an IPS mode or ECB mode, the twist angle is 0°. In the IPS mode, an electrode is disposed only on the lower substrate 8, and an electrical field parallel to the substrate surface is applied. Moreover, in an OCB mode, a twist angle does not exist, and a tilt angle is made large; and in a VA mode, the liquid crystal molecule 12 orients vertically to the upper and lower substrates.

Here, the size of the product (Δnd) of the thickness (d) of the liquid crystal layer and the refractive index anisotropy (Δn) changes the brightness at the time of white display. For this reason, in order to obtain the maximum brightness, its range is set up at every display mode.

In general, by performing lamination so as to make a crossing angle between an absorption axis 7 of the upper polarizing plate 6 and an absorption axis 18 of the lower polarizing plate 17 substantially orthogonal, a high contrast is obtained. In the liquid crystal cell, a crossing angle between the absorption axis 7 of the upper polarizing plate 6 and the rubbing direction of the upper substrate 10 varies depending upon the liquid crystal display mode. In the TN mode and IPS mode, the crossing angle is generally set up either parallel or vertical. In the OCB mode and ECB mode, the crossing angle is often set up at 45°. However, for the purpose of adjusting the color tone of the display color or viewing angle, the optimum value is different in every display mode, and therefore, the crossing angle is not limited to the foregoing ranges.

The liquid crystal display device in which the polarizing plate of the invention is used is not limited to the construction as shown in FIG. 3 but may contain other members. For example, a color filter may be disposed between the liquid crystal cell and the polarizer. Furthermore, viewing angle enlarging filters as described previously can be separately disposed between the liquid crystal cell and the polarizing plate. The polarizing plates 6 and 17 and the optically anisotropic layers (the viewing angle enlarging films) 8 and 15 may be disposed in a laminated state as stuck with an adhesive or may be disposed as a so-called integrated elliptical polarizing plate in which the one-sided protective film in the side of the liquid crystal cell is used for enlarging the viewing angle.

Furthermore, in the case where the liquid crystal display device in which the polarizing plate of the invention is used as a transmission type, a cold cathode or hot cathode fluorescent tube, or a backlight using, as a light source, a luminescent diode, a field emission element, or an electro-luminescent element can be disposed in the back side. Moreover, the liquid crystal display device in which the polarizing plate of the invention is used may be of a reflection type. In such case, only one polarizing plate may be disposed in the viewing side, and a reflection film is disposed in the back side of the liquid crystal cell or on the inner surface of the lower substrate of the liquid crystal cell. As a matter of course, a front light using the foregoing light source may be provided in the viewing side of the liquid crystal cell.

### EXAMPLE 1

### Production of Cellulose Acylate Film 101

### <Preparation of Cellulose Acetate Solution>

Cellulose acetate solution A was prepared by putting the following composition in a mixing tank and stirring to thereby dissolve each component.

Composition of cellulose acylate solution A:

| | |
|---|---|
| Cellulose acetate having acetylation | 100.0 mass parts |
| degree of 2.94 | |
| Retardation decreasing agent A-12 | 12.0 mass parts |
| Methylene chloride (first solvent) | 402.0 mass parts |
| Methanol (second solvent) | 60.0 mass parts |

### <Preparation of Matting Agent Solution>

A matting agent solution was prepared by putting the following composition in a disperser and stirring the composition to thereby dissolve each component.

Composition of matting agent solution:

| | |
|---|---|
| Silica particles having an average | 2.0 mass parts |
| particle size of 20 nm (AEROSIL R972, | |
| manufactured by Nippon Aerosil Co., Ltd.) | |
| Methylene chloride (first solvent) | 75.0 mass parts |
| Methanol (second solvent) | 12.7 mass parts |
| Cellulose acylate solution A | 10.3 mass parts |

### <Preparation of UV Absorber Solution>

A UV absorber solution was prepared by putting the following composition in a mixing tank and stirring the composition with heating to thereby dissolve each component

Composition of UV absorber solution:

| | |
|---|---|
| UV absorber UV-1 | 2.0 mass parts |
| UV absorber UV-2 | 2.0 mass parts |
| Methylene chloride (first solvent) | 58.4 mass parts |
| Methanol (second solvent) | 8.7 mass parts |
| Cellulose acylate solution A | 12.8 mass parts |

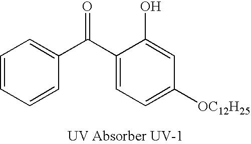

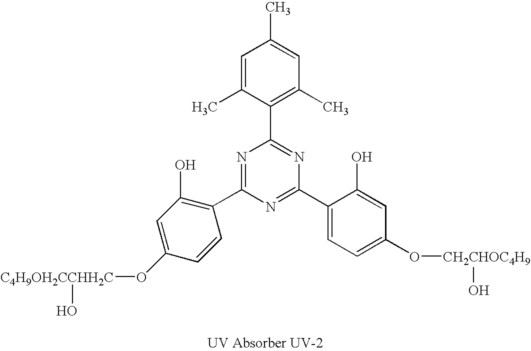

After filtering 94.6 mass parts of the above cellulose acylate solution A, 1.3 mass parts of the matting agent solution, and 4.1 mass parts of the UV absorber solution, the components were mixed and cast in a width of 1,500 mm with a band casting machine. The obtained film with a residual solvent content of 40 mass % was stripped off the band and laterally stretched to an extent of 8% of the stretching magnification at 100° C. with maintaining the film with tenter clips, and the film was dried until the residual solvent amount reached 5 mass % (drying 1). The film was then held at 100° C. for 30 seconds while maintaining the width after stretching. Subsequently, the film was released from the tenter clips, the film was cut by 5% each from both ends of the transverse direction, passed through a drying zone at 140° C. for 30 minutes in the state of the transverse direction being free (not held) (drying 2), and then wound on a roll. The residual solvent content of the finished cellulose acylate film was 0.1 mass %, and the thickness was 80 μm.

### (Production of Cellulose Acylate Films 102 to 106)

Cellulose acylate films 102 to 106 were produced in the same manner as above, except that the kinds of the cellulose acylate, retardation decreasing agent, the kind and addition amount of UV absorber, and the temperature of the drying zone of each sample were changed as shown in Table 1 below.

### COMPARATIVE EXAMPLE 1

### Production of Cellulose Acylate Film 107

Cellulose acylate film 107 was produced in the same manner as above, except that the drying zone temperature in cellulose acylate film 101 in Example 1 was changed to 130° C.

### COMPARATIVE EXAMPLE 2

### Production of Cellulose Acylate Film 108

Cellulose acylate film 108 was produced in the same manner as in Example 1, except that the retardation decreasing agent was changed to D-1 as shown in Table 1.

### EXAMPLE 2

### Production of Cellulose Acylate Film 201

Cellulose acylate solution B was prepared by putting the following composition in a mixing tank and stirring the composition with heating to thereby dissolve each component.

### <Composition of Cellulose Acylate Solution B>

| | |
|---|---|
| Cellulose acetate having acetylation | 100 mass parts |
| degree of 2.91 | |
| Retardation decreasing agent A-12 | 9.0 mass parts |
| Methylene chloride (first solvent) | 280 mass parts |
| Methanol (second solvent) | 64 mass parts |
| 1-Butanol | 21 mass parts |

A UV absorber solution C was prepared by putting the following composition in other mixing tank and stirring the composition with heating to thereby dissolve each component.

### <Composition of UV Absorber Solution C>

| | |
|---|---|
| Methylene chloride | 80 mass parts |
| Methanol | 20 mass parts |
| UV absorber UV-1 | 2 mass parts |
| UV absorber UV-2 | 4 mass parts |

UV absorber solution C (40 mass parts) was added to 474 mass parts of cellulose acylate solution B, and the components were thoroughly stirred to prepare a dope.

The dope was cast on a drum cooled at 0° C. from a casting nozzle. The film with a residual solvent amount of 75 mass % was stripped off the drum, both ends in the transverse direction of the film was fixed with a pin tenter (the pin tenter disclosed in JP-A-4-1009, FIG. 3), and the film was dried at 115° C. until the residual solvent amount reached 5 mass % (drying 1) with maintaining the intervals so that the stretching magnification in the transverse direction (a perpendicular direction to the machine direction) became 7%. After that, the film was further dried at 140° C. for 20 minutes by passing through the rollers of a heat treatment apparatus (drying 2), whereby cellulose acylate film 201 having a thickness of 70 μm was obtained

### (Production of Cellulose Acylate Film 202)

Cellulose acylate film 202 was produced in the same manner as in the production of cellulose acylate film 201, except that the retardation decreasing agent was changed to (A-15).

### COMPARATIVE EXAMPLE 3

### Production of Cellulose Acylate Film 203

Cellulose acylate film 203 was produced in the same manner as in the production of cellulose acylate film 202, except that the temperature in drying 2 was changed to 130° C.

### COMPARATIVE EXAMPLE 4

### Production of Cellulose Acylate Film 204

After filtering 94.6 mass parts of cellulose acylate solution A in Example 1, 1.3 mass parts of the matting agent solution, and 4.1 mass parts of the UV absorber solution, the components were mixed and cast in a width of 1,500 mm with a band casting machine. The obtained film with a residual solvent content of 10 mass % was stripped off the band and laterally stretched to an extent of 8% of the stretching magnification at 140° C. with maintaining the film with tenter clips, and the film was dried until the residual solvent amount reached 1 mass % (drying 1). Subsequently, the film was released from the tenter clips, the film was cut by 5% each from both ends of the transverse direction, passed through a drying zone at 130° C. for 15 minutes (drying 2), and then wound on a roll. The residual solvent content of the finished cellulose acylate film 204 was 0.08 mass %, and the thickness was 81 μm.

TABLE 1

| | Substitution Degree of Cellulose | | | | | | | | |
|---|---|---|---|---|---|---|---|---|---|
| | Total | Degree | | | | | | Atmospheric | |
| | Degree | of | | Retardation Decreasing agent | | | | Temperature | |
| Sample | of | Acetyla- | | | | Addition | Tg | in Drying 2 | |
| No. | Acetylation | tion | Propionyl | Kind | logP | Amount*a) | (° C.) | (° C.) | Remarks |
| Film 101 | 2.94 | 2.94 | 0.0 | A-12 | 4.6 | 12 | 136 | 140 | Invention |
| Film 102 | 2.94 | 2.94 | 0.0 | A-15 | 3.1 | 12 | 135 | 140 | Invention |
| Film 103 | 2.94 | 2.94 | 0.0 | C-3 | 4.3 | 12 | 135 | 140 | Invention |
| Film 104 | 2.94 | 2.94 | 0.0 | A-16 | 1.3 | 12 | 139 | 140 | Invention |
| Film 105 | 2.90 | 2.40 | 0.5 | A-12 | 4.6 | 6 | 130 | 135 | Invention |
| Film 106 | 2.94 | 2.94 | 0.0 | C-403 | 7.5 | 12 | 130 | 135 | Invention |
| Film 107 | 2.94 | 2.94 | 0.0 | A-15 | 3.1 | 12 | 135 | 130 | Comparison |
| Film 108 | 2.94 | 2.94 | 0.0 | D-1 | 3.1 | 12 | 133 | 140 | Comparison |
| Film 201 | 2.91 | 2.91 | 0.0 | A-12 | 4.6 | 9 | 139 | 145 | Invention |
| Film 202 | 2.91 | 2.91 | 0.0 | A-15 | 3.1 | 9 | 139 | 145 | Invention |
| Film 203 | 2.91 | 2.91 | 0.0 | A-15 | 3.1 | 9 | 139 | 130 | Comparison |
| Film 204 | 2.94 | 2.94 | 0.0 | A-15 | 3.1 | 12 | 135 | 130 | Comparison |

*a) Percent by weight based on the cellulose acylate

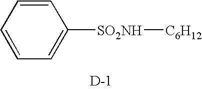

### EXAMPLE 3

### Measurement of Physical Characteristics of Film

### <Measurement of Optical Characteristics>

Re and Rth at 25° C. 10% RH, 25° C. 60% RH, and 25° C. 80% RH respectively were measured with a birefringence meter KOBRA 21ADH (manufactured by Oji Scientific Instruments). The wavelength at measurement was 590 nm.

Further, with respect to wavelengths from 400 to 700 nm, Re and Rth at 25° C. 60% RH were measured with an ellipsometer (manufactured by JASCO Corporation)

### <Measurement of Sonic Speed>

Sonic speeds in MD and TD of the film were measured with ST-110 (manufactured by Nomura Corporation Co., Ltd.).

### <Measurement of Orientation Coefficients of Main Chain and Carbonyl Group in Cellulose Acylate>

Measurement was performed with polarization ATR method and FTS7000 (manufactured by Varian Semiconductor Equipment K.K.). Specifically, on the above measuring conditions, light was made incident in parallel with the machine direction, the absorbance at the time when the polarized light was perpendicular to the incident plane (ATEx) and the absorbance at the time when the polarized plane was parallel with the incident plane (ATMx) were found, and then ATEy and ATMy were measured similarly by making light incident in parallel with the transverse direction, and fxy (in-plane orientation coefficient) and fxz (orientation coefficient in the thickness direction) were computed according to the above expression.

### <Measurement of Dimensional Variation Rate>

Pieces of samples having a size of 250 mm (in MD)×50 mm (in TD), and 50 mm (in MD)×250 mm (in TD) were respectively cut out. The dimensions of each sample before and after aging at 100° C. for 250 hours were measured with a pin gauge, and the rate of dimensional variation both in MD and TD was measured by the following equation.

Rate of dimensional variation=[(dimension after aging)/(dimension before aging)]/(dimension before aging)

### <Measurement of Retention of Additive>

A piece of sample was cut out of the film in a size of 120 mm×30 mm. The sample was aged at 140° C. for 10 hours, extracted with THF or methylene chloride, and then the content of additive in the film was determined by liquid chromatography or gas chromatography. The residual rate of additive after aging was found by the following equation.

The residual rate of additive=[(content of additive in film after aging)/(content of additive in film before aging)]×100.

The results obtained are shown in Table 2 below. From the results in Table 2, it is seen that the cellulose acylate film produced by the method of the invention shows small retardation throughout the visible wavelength region, variation in retardation due to humidity is small, dimensional variation after high temperature hysteresis is small, and is excellent in the retention of an additive.

TABLE 2

| | | | | | Re (590) at | Rth (590) at | |
|---|---|---|---|---|---|---|---|
| | Re at 25° C., | | Rth at 25° C., | | 25° C. 80% RH- | 25° C. 80% RH- | Sonic Speed |
| | 60% RH | | 60% RH | | Re (590) at | Rth (590) at | Ratio |
| Sample No. | Re (400) | Re (700) | Rth (400) | Rth (700) | 25° C. 10% RH | 25° C. 10% RH | MD/TD |
| Film 101 | 1.9 | 1.4 | −4 | 4 | 0.7 | 18 | 1.03 |
| Film 102 | 2.4 | 2.1 | −9 | 0 | 0.9 | 19 | 1.03 |
| Film 103 | 1.7 | 1.3 | −4 | 3 | 0.8 | 17 | 1.03 |
| Film 104 | 0.5 | 0.3 | 15 | 24 | 0.4 | 24 | 1.03 |
| Film 105 | 1.4 | 1 | −6 | 8 | 0.2 | 6 | 1.04 |
| Film 106 | 1.3 | 0.8 | 8 | 24 | 0.8 | 29 | 1.03 |
| Film 107 | 0.4 | 1.1 | 5 | 20 | 2.1 | 32 | 0.99 |
| Film 108 | 1.4 | 0.9 | 25 | 29 | 1.0 | 24 | 1.03 |
| Film 201 | 2.8 | 0.4 | −4 | 5 | 2.1 | 24 | 1.03 |
| Film 202 | 2.6 | 0.5 | −6 | 6 | 2.4 | 28 | 1.03 |
| Film 203 | 3.4 | 0.2 | 9 | 26 | 8.0 | 36 | 1.02 |
| Film 204 | 0.4 | 1 | 5 | 21 | 2 | 31 | 0.99 |

| | Orientation | | Orientation | | Rate of Dimensional | | Residual Rate | |
|---|---|---|---|---|---|---|---|---|
| | Coefficient | | Coefficient | | Variation by Aging | | of Additive | |
| | of Main Chain | | of Carbonyl Group | | at 100° C., 250 Hours | | after Aging | |
| Sample | In-Plane | Thickness | In-Plane | Thickness | (%) | | at 140° C. for 10 | |
| No. | Direction | Direction | Direction | Direction | MD | TD | Hours | Remarks |
| Film 101 | 0.01 | 0.09 | 0.00 | −0.05 | −0.08 | −0.07 | 100 | Invention |
| Film 102 | 0.00 | 0.12 | −0.02 | −0.07 | −0.07 | −0.07 | 99 | Invention |
| Film 103 | 0.01 | 0.10 | −0.01 | −0.06 | −0.09 | −0.08 | 100 | Invention |
| Film 104 | −0.02 | 0.07 | 0.01 | −0.03 | −0.12 | −0.10 | 100 | Invention |
| Film 105 | 0.00 | 0.08 | 0.00 | −0.05 | −0.14 | −0.14 | 99 | Invention |
| Film 106 | −0.03 | 0.05 | 0.01 | −0.03 | −0.13 | −0.10 | 98 | Invention |
| Film 107 | −0.05 | 0.03 | 0.03 | −0.01 | −0.21 | −0.14 | 97 | Comparison |
| Film 108 | −0.03 | 0.05 | 0.01 | −0.03 | −0.14 | −0.10 | 92 | Comparison |
| Film 201 | −0.01 | 0.09 | −0.03 | −0.08 | −0.08 | −0.07 | 100 | Invention |
| Film 202 | −0.01 | 0.08 | −0.02 | −0.08 | −0.08 | −0.08 | 99 | Invention |
| Film 203 | −0.05 | 0.03 | 0.03 | −0.01 | −0.21 | 0.14 | 96 | Comparison |
| Film 204 | −0.03 | 0.05 | 0.03 | −0.01 | −0.21 | −0.14 | 97 | Comparison |

### EXAMPLE 4

### Saponification Treatment

Cellulose acylate film 101 produced in Example 1 was immersed in an aqueous solution containing 1.5 mol/liter of sodium hydroxide at 55° C. for 10 minutes. The film was then washed in a water washing tank at room temperature, neutralized with sulfuric acid of 0.05 mol/liter at 30° C., again washed in the water washing tank at room temperature, and dried by hot air of 100° C.

Cellulose acylate films 102 to 106 and 201 were also subjected to saponification treatment in the same manner.

### COMPARATIVE EXAMPLE 5

Cellulose acylate films 107, 108, 203 and 204 produced in Comparative Examples 1 to 3 were also subjected to saponification treatment in the same manner as in Example 4

### EXAMPLE 5

### Determination of Elution Amount of Additive in Saponification Solution

With 1 liter of saponification solution used for the treatment of 100 g of a film on the same condition as in Example 4, the residual amount of the additive was determined by liquid chromatography or gas chromatography.

With retardation decreasing agent C-403, the decomposed product having the structure shown below was determined, and the eluted amount was computed assuming that the equimolar retardation decreasing agent C-403 was eluted.

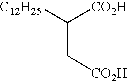

(Measurement of Retardation after Saponification)

The retardation (measurement wavelength: 590 nm) at 25° C. 60% RH of the film after saponification treatment was measured in the same manner as in Example 3, and the retardation fluctuation before and after saponification treatment was found.

The results obtained are shown in Table 3 below. From the results in Table 3, it can be seen that the cellulose acylate film in the invention is little in elution of additive to a saponification treatment solution, and also the retardation fluctuation by saponification treatment is little and so preferred.

TABLE 3

| | Eluted | | | |
|---|---|---|---|---|
| | amount of | | Rth (590) | |
| | Additive into | Re (590) before | before | |
| | Saponification | Saponification- | Saponification- | |
| Sample | Solution | Re (590 after | Rth (590) after | |
| No. | (mg) | Saponification | Saponification | Remarks |
| Film | 22 | 0.1 | 1.1 | Invention |
| 101 | | | | |
| Film | 71 | 0.1 | 2.9 | Invention |
| 102 | | | | |
| Film | 5 | 0.2 | 2.5 | Invention |
| 103 | | | | |
| Film | 32 | 0.1 | 1.4 | Invention |
| 104 | | | | |
| Film | 14 | 0.2 | 2.3 | Invention |
| 105 | | | | |
| Film | 89 | 0.4 | 4.4 | Invention |
| 106 | | | | |
| Film | 110 | 0.3 | 5.1 | Comparison |
| 107 | | | | |
| Film | 350 | 0.6 | 6.2 | Comparison |
| 108 | | | | |
| Film | 22 | 0.1 | 1.4 | Invention |
| 201 | | | | |
| Film | 68 | 0.2 | 2.8 | Invention |
| 202 | | | | |
| Film | 115 | 0.3 | 5.7 | Comparison |
| 203 | | | | |
| Film | 114 | 0.3 | 5.0 | Comparison |
| 204 | | | | |

### EXAMPLE 6

### Production of Polarizing Plate (101-a)

A polarizer was prepared by adsorbing iodine onto a stretched polyvinyl alcohol film, and cellulose acylate film 101 subjected to saponification treatment in Example 4 was stuck on both sides of the polarizer with a polyvinyl alcohol adhesive. The transmission axis of the polarizer and the machine direction of the cellulose acylate film at manufacturing time are arranged so as to be perpendicular, thus polarizing plate (101-a) was prepared

(Production of Polarizing Plate (101-b) with Optical Compensation Function)

An optically compensatory film obtained by uniaxial stretching of polycarbonate was further stuck on one side of polarizing plate (101-a) to produce polarizing plate with an optical compensation function (101-b). The slow axis of the in-plane retardation of the optically compensatory film and the transmission axis of the polarizing plate were crossed. In-plane retardation Re and the thickness direction retardation Rth of the optically compensatory film used were 260 nm and 130 nm respectively.

(Production of Polarizing Plates (102-a) to (106-a), (201-a) and (202-a) and Polarizing Plates with Optical Compensation Function (102-b) to (106-b), (201-b) and (202-b))

With saponification treated cellulose acylate films 102 to 106, 201 and 202, polarizing plates (102-a) to (106-a), (201-a) and (202-a), and polarizing plates with optical compensation function (102-b) to (106-b), (201-b) and (202-b) were produced in the same manner as in the production of polarizing plates (101-a) and (101-b).

### COMPARATIVE EXAMPLE 6

With saponification treated cellulose acylate films 107, 108, 203 and 204 prepared in Comparative Example 5, polarizing plates (107-a), (108-a), (203-a) and (204-a), and polarizing plates with optical compensation function (107-b), (108-b), (203-b) and (204-b) were produced in the same mariner as in Example 6.

### EXAMPLE 7

### (Evaluation of Actual Integration into IPS Liquid Crystal Display Device

Liquid crystal display device 101 was produced by superposition and integration in order of polarizing plate with an optical compensation function (101-b), IPS type liquid crystal cell and polarizing plate (101-a). At this time, the transmission axes of the upper and lower polarizing plates were crossed, and the transmission axis of the upper polarizing plate was made parallel with the molecular long axis direction of the liquid crystal cell (that is, the slow axis of the optically compensatory layer and the molecular long axis direction of the liquid crystal cell were crossed). Liquid crystal cells, electrodes and substrates conventionally used as IPS can be used as they are. The orientation of the liquid crystal cell is horizontal orientation, the liquid crystal has positive dielectric constant anisotropy, and commercially available products developed for IPS liquid crystal can be used. As the physical characteristics of the liquid crystal cell, Δn of the liquid crystal was 0.099, cell gap of the liquid crystal layer was 3.0 μm, the pretilt angle was 5°, rubbing direction of the substrate was 75° on the upper and lower substrates.

With polarizing plates (108-a) and (108-b), liquid crystal display device 108 was produced in the same manner.

The produced liquid crystal display devices were continuously lighted in the atmospheres at 25° C. 10% RH and 25° C. 80% RH respectively, and a light leak rate and the tint in the time of black display at the azimuth angle direction of 45° and the polar angle direction of 70° from the front of the display device were measured. The polarizing plate 101 of the invention was little in the variation in tint by atmospheric humidity and also a light leak rate in use for a long period of time is little, further free from defects in luminescent spots.

### INDUSTRIAL APPLICABILITY

The invention can provide a protective film of a polarizing plate stable in retardation and dimensional stability in various use environments. The invention can produce a polarizing plate free from facial defects and excellent in optical compensation performances. Further, the invention can provide a high grade liquid crystal display device by using a polarizing plate having stable optical compensation performances in various use environments in the liquid crystal display device.

The entire disclosure of each and every foreign patent application from which the benefit of foreign priority has been claimed in the present application is incorporated herein by reference, as if fully set forth.

1. A cellulose acylate film, which has an in-plane retardation Re and a retardation in a thickness direction Rth at 25° C., 60% RH satisfying relationships of equations (A) and (B),
wherein an amount of an elution of an additive per 100 g of the cellulose acylate film is 100 mg or less when the cellulose acylate film is immersed in 1 liter of 1.5 mol/liter of sodium hydroxide solution at 55° C. for 10 minutes:
0 nm≦Re(λ)≦10 nm (A)
−25 nm≦Rth(λ)≦25 nm (B)
wherein Re (λ) and Rth (λ) represent Re and Rth measured at a wavelength of λ nm respectively; and
λ is from 400 to 700 nm.

2. A cellulose acylate film, which has an in-plane retardation Re and a retardation in a thickness direction Rth at 25° C., 60% RH satisfying relationships of equations (A) and (B),
wherein variations in the retardations Re and Rth at 25° C., 60% RH before and after immersion of the cellulose acylate film in 1.5 mol/liter of sodium hydroxide solution at 55° C. for 10 minutes satisfy relationships of equations (C) and (D):
0 nm≦Re(590)≦10 nm (A)
−25 nm≦Rth(590)≦25 nm (B)
2 nm≦[(Re before immersion treatment)−(Re after immersion treatment)]≦2 nm (C)
−3 nm≦[(Rth before immersion treatment)−(Rth after immersion treatment)]≦3 nm (D)
wherein in the equations (A) and (B), Re (590) and Rth (590) represent Re and Rth measured at a wavelength of 590 nm, respectively; and
in equations (C) and (D), Re and Rth are values at a wavelength of 590 nm.

3. A cellulose acylate film, which has an in-plane retardation Re and a retardation in a thickness direction Rth at 25° C., 60% RH satisfying relationships of equations (A) and (B),
wherein a residual rate of an additive in the cellulose acylate film after aging at 140° C. for 10 hours is 98% or more:
0 nm≦Re(λ)≦10 nm (A)
−25 nm≦Rth(λ)≦25 nm (B)
wherein Re (λ) and Rth (λ) represent Re and Rth measured at a wavelength of λ nm, respectively; and
λ is from 400 to 700 nm.

4. A cellulose acylate film, which has an in-plane retardation Re and a retardation in a thickness direction Rth at 25° C., 60% RH satisfying relationships of equations (A) and (B),
wherein orientation coefficients of a main chain and a carbonyl group in the cellulose acylate film satisfy relationships of equations (E) to (H):
0 nm≦Re(λ)≦10 nm (A)
−25 nm≦Rth(λ)≦25 nm (B)
0.02≦an orientation coefficient of a main chain in a thickness direction≦0.20 (E)
−0.04≦an orientation coefficient of a main chain in an in-plane direction≦0.10 (F)
−0.10≦an orientation coefficient of a carbonyl group in a thickness direction≦−0.02 (G)
−0.10≦an orientation coefficient of a carbonyl group in an in-plane direction≦0.02 (H)
wherein in equations (A) and (B), Re (λ) and Rth (λ) represent Re and Rth measured at a wavelength of λ nm, respectively; and
λ is from 400 to 700 nm.

5. A method for producing a cellulose acylate film comprising:
a process of subjecting a cellulose acylate film that comprises an additive comprising an aliphatic compound to thermal shrinkage treatment at an atmospheric temperature higher than a glass transition temperature Tg in a state where at least one of a transverse direction and a machine direction of the cellulose acylate film is free.

6. The cellulose acylate film according to claim 1, which is produced by a method for producing a cellulose acylate film comprising:
a process of subjecting a cellulose acylate film that comprises an additive comprising an aliphatic compound to thermal shrinkage, treatment at an atmospheric temperature higher than a glass transition temperature Tg in a state where at least one of a transverse direction and a machine direction of the cellulose acylate film is free.

7. The cellulose acylate film according to claim 6,
wherein the aliphatic compound has at least one non-dissociable polar group and an octanol/water distribution coefficient (logP) of from 1 to 10.

8. The cellulose acylate film according to claim 6,
wherein the aliphatic compound is a compound represented by formula (1): 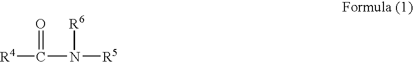
wherein R⁴, R⁵ and R⁶ each independently represents an alkyl group, which may have a substituent.

9. The cellulose acylate film according to claim 1,
wherein a ratio of a sonic speed in a machine direction MD and a sonic speed in a transverse direction TD satisfies equation (I):
1.0<(sonic speed in MD)/(sonic speed in TD)<1.1 (I)

10. The cellulose acylate film according to claim 1,
wherein a difference between Re (590) at 25° C. 80% RH and Re (590) at 25° C. 10% RH is from −10 to 10 nm.

11. The cellulose acylate film according to claim 1,
wherein a difference between Rth (590) at 25° C. 80% RH and Rth (590) at 25° C. 10% RH is from −30 to 30 nm.

12. The cellulose acylate film according to claim 1,
wherein each of a dimensional variation in a machine direction MD and a dimensional variation in a transverse direction TD before and after aging at 100° C. for 250 hours is from −0.15 to 0.15%.

13. A polarizing plate comprising:
a polarizer; and
at least two protective films stuck on both sides of the polarizer,
wherein at least one of the at least two protective films is a cellulose acylate film according to claim 1.

14. The polarizing plate according to claim 13, which has an optical compensation performance.

15. A liquid crystal display device comprising:
a liquid crystal cell; and
at least two polarizing plates arranged on both sides of the liquid crystal cell,
wherein at least one of the at least two polarizing plates is a polarizing plate according to claim 13.
